(19) United States
(12) Patent Application Publication
(10) Pub. No.: US 2024/0417654 A1
(43) Pub. Date: Dec. 19, 2024

(54) CO-CULTURES FOR EFFICIENTLY PRODUCING A FERMENTED BEVERAGE

(71) Applicant: HEINEKEN SUPPLY CHAIN B.V., Amsterdam (NL)

(72) Inventors: Jasper Andries DIDERICH, Amsterdam (NL); Thomas PERLI, Amsterdam (NL); Maria VITALI-VASQUEZ, Amsterdam (NL); Jean-Marc George DARAN, Amsterdam (NL)

(21) Appl. No.: 18/703,090

(22) PCT Filed: Oct. 24, 2022
(86) PCT No.: PCT/NL2022/050601

§ 371 Date: Apr. 19, 2024

(30) Foreign Application Priority Data
Oct. 22, 2021 (EP) 21204308.7

(51) Int. Cl. C12C 12/00; C12C 11/00

(52) U.S. Cl. CPC C12C 12/006; C12C 11/003; C12C 12/004

(57) ABSTRACT

The invention relates to methods of producing a fermented beverage by employing at least two fermentative yeast strains, to a fermented beverage that may be produced by the methods of the invention, and to the use of at least two fermentative yeast strains for the production of a fermented beverage.

### FIELD OF THE INVENTION

The invention is in the field of microbiology. In particular, the invention relates to the use of yeast strains with differences in substrate preferences and/or consumption capacities towards sugars for producing a fermented product, preferably a beer.

### 1. BACKGROUND OF THE INVENTION

The first step of brewer's wort sugar fermentation is the transport of sugars across the cell membrane. The efficiency and completeness of the wort sugar assimilation depends on the abundance and specificity of transport proteins for the fermentable sugars glucose, fructose, maltose and maltotriose, but also on the metabolism following the entrance of the sugars into the cell. The conversion of sugar mixtures by micro-organisms is often regulated in such a way that cells will allocate its cellular resources for the conversion of different substrates in a sequential way, starting with a sugar that is most easily converted. During fermentation of brewers wort and in particular during high gravity wort fermentation, this will result in reduced attenuation and considerable residual sugar concentrations. This is due at least in part to the fact that the alcohol that is produced will hamper fermentation of the remaining sugars, which in general will be more difficult to convert.

This problem has been recognized in processes for the production of alcohol. For example, the published international patent application WO2013/181496 proposes to employ a combination of different yeast strains. As the goal of WO2013/181496 is the production of alcohol, said combination includes one or more high alcohol tolerant yeasts and one or more maltotriose positive yeasts. In addition, a preferred substrate for fermentation comprises starch such as potato or wheat to which no hop is added. A preferred fermentation temperature is between 30° C. and 40° C. These features cannot be employed for the production of a fermented beverage such as a beer, especially a lager beer.

There is thus a need for developing strategies to overcome residual sugar concentrations at least in part in methods for producing a fermented beverage such as a beer, especially a lager beer. Said strategies preferably enable high gravity wort fermentation.

### 2. BRIEF DESCRIPTION OF THE INVENTION

In nature in general, but in particular in microbiology, trade-offs between nutrient preferences have resulted in organisms that are specialized in wort sugar assimilation. Here a method is provided that will make use of the variety in specialization. The conversion of substrate mixtures by consortia of specialized strains with different substrate specificities, e.g. with a preference for maltose or maltotriose, will improve mixed-sugar fermentation kinetics, when compared to the application of a single strain such as a generalist strain. A consortia of specialized strains will improve attenuation, at least in part, and result in increased ethanol yields, especially when fermenting high gravity wort. In contrast to the disclosure of WO2013/181496, said combination surprisingly not necessarily includes one or more high alcohol tolerant yeast.

The invention therefore provides a method of producing a fermented beverage, comprising the steps of providing a wort; adding hop and at least two fermentative yeast strains to the wort, whereby said at least two fermentative yeast strains differ in their substrate specificities towards sugars in the wort, especially towards glucose, maltose, fructose and/or maltotriose; incubating the wort with the at least two fermentative yeast strains for a period of time to thereby produce a fermented beverage. The at least two fermentative yeast strains may optionally be removed from the fermented wort at the end of the incubation period.

The methods of the invention surprisingly enable improved sugar fermentation kinetics, such that a desired final gravity is reached at an earlier time point, when compared to conventional fermentation employing a single, non-specialist, yeast strain. A person skilled in the art will understand that this reduction in time is achieved when a particular wort is fermented by at least two fermentative yeast strains versus a single yeast strain such as a non-specialist yeast strain, even when all other circumstances such as timing, amount of inoculation, fermentation temperature are substantially identical.

In addition, the methods of the invention allow fermentation of high gravity wort, or even of ultrahigh gravity wort, having a gravity of more than 16° Plato, such as 17° Plato, 18° Plato, 19° Plato, 20° Plato, 21° Plato, 22° Plato, or 23° Plato. This may result in producing fermented beverages with high alcohol content, such as more than 5% alcohol by volume (ABV), more than 6% ABV, or even more than 7% ABV.

Said at least two fermentative yeast strains may be simultaneously or sequentially added to the wort.

In a preferred method of the invention, fermentation of a high gravity wort, such as a wort having more than 16° Plato, including 17° Plato, 18° Plato, 19° Plato, or 20° Plato, results in a fermented beverage with a final gravity of less than 2.5° Plato within a reduced time period, such as within 15 days of fermentation of a 16-18° Plato wort.

In a preferred method of the invention, said at least two fermentative yeast strains are Saccharomyces cerevisiae, S. pastorianus (S. carlsbergensis), S. eubayanus yeast strains, and/or a mixture or a hybrid thereof. Said at least two fermentative yeast strains may be strains from a the same yeast species, such as a single hybrid species, or from two or more yeast species, provided that the strains have different substrate specificities towards sugars, especially towards glucose, fructose, maltose and/or maltotriose.

In a preferred method of the invention, the at least two fermentative yeast strains do not produce 4-vinyl guaiacol, for example by inactivation of a putative flavin prenyltransferase (PAD1) gene and/or a ferulic acid decarboxylase (FDC1) gene.

In preferred method of the invention, fermentation is performed at 6-25° C., preferably at 8-15° C.

In preferred method of the invention, the fermented beverage is a beer, preferably a lager beer.

In preferred method of the invention, a fermentative yeast strain with maltose substrate preference is Saccharomyces pastorianus strain CBS 1483.

In preferred method of the invention, a fermentative yeast strain with maltotriose substrate preference is S. pastorianus strain CBS 1513.

The invention further provides a fermented beverage, preferably beer, more preferably lager beer, that has a high alcohol content, such as more than 5% alcohol by volume (ABV), more than 6% ABV, or even more than 7% ABV. Said fermented beverage, preferably beer, more preferably lager beer, preferably is produced by the methods of the invention.

The invention further provides a use of a combination of at least two fermentative yeast strains that differ in their substrate specificities towards sugars in the wort, especially towards glucose, fructose, maltose and/or maltotriose, for the production of a fermented beverage, preferably a beer, most preferably a lager beer.

Said at least two fermentative yeast strains may be added simultaneously or sequentially to the wort.

Said at least two fermentative yeast strains preferably comprise a fermentative yeast strain with maltose substrate preference such as Saccharomyces pastorianus strain CBS 1483, a fermentative yeast strain with maltotriose substrate preference such as S. pastorianus strain CBS 1513, or a combination thereof.

### 3. FIGURE LEGENDS

FIG. 1: Representative sugar consumption profile for maltose (circles) and maltotriose (squares) of strain WS34/70. Average values from biological triplicates are shown. Points used to calculate each consumption rate are shown in black circles for maltose and black squares for maltotriose.

FIG. 2: Distribution of M2/M3 rates ratios across all tested strains. Rates ratios for CBS1483, CBS1513, and WS34/70 are shown in white circles, white squares, and white triangles, respectively.

FIG. 3. Fermentation of a 20° P wort. Shown are the gravity (° Plato) course (A), maltotriose content (B); maltose content (C); ethanol production levels during (D) and final (E), during fermentation of a 20° P wort with WS34/70, CBS 1513, CBS 1483, and combinations of CBS 1513 and CBS 1483 as indicated.

FIG. 4. Fermentation of a 23° P wort. Shown are the gravity (° Plato) course (A), maltotriose content (B) and maltose content (C) during fermentation of a 23° P wort with CBS 1513, CBS 1483, and combinations of CBS 1513 and CBS 1483 as indicated.

FIG. 5. Comparison of 20° P wort fermentation and 23° P wort fermentation. Shown are the gravity (° Plato) course (A) and final ethanol production levels (B) for combinations of CBS 1513 and CBS 1483 as indicated.

FIG. 6: Fermentation of wort with co-cultures of Saccharomyces strains. A) Plato profiles, B) Maltose profiles, C) Maltotriose profiles and D) final ethanol titers of 23° P wort fermentation of a Saccharomyces cerevisiae strain mix comprising the Superstart and Thermosacc strains (▪) and of a Saccharomyces pastorianus strain mix comprising the strains CBS1483 and CBS1513 (□). The values represent averages±mean deviations of data obtained from independent quadruplicate cultures.

FIG. 7: CO2 profiles of wort. Fermentation with co-cultures of Saccharomyces cerevisiae strain mix comprising the Superstart and Thermosacc strains (Lallemand) (▪) and of a Saccharomyces pastorianus strain mix comprising the strains CBS1483 and CBS1513 (□). The profiles shown are from a single representative experiment out of a set of quadruplicate.

### 4. DETAILED DESCRIPTION OF THE INVENTION

### 4.1 Definitions

The term “fermented beverage”, as is used herein, refers to a beer product that is produced by fermentation of, for example, crops and products thereof such as grains, rice, grapes and other fruits, nuts and/or exudations from, e.g. agave, yucca and cactus. A preferred fermented beverage is a beer. A more preferred fermented beverage is a lager beer.

The term “gene”, as is used herein, refers to any and all cis-acting genomic sequences that ensure that a product encoded by the gene is expressed. Said cis-acting genomic sequences include enhancer and promotor sequences, exonic and intronic sequences, terminator sequences etc. Said product may be an RNA molecule, such as a mRNA molecule or an siRNA molecule, and/or a protein.

The term “inactivated gene”, as is used herein, indicates a gene that is not able to perform its normal function. E.g. for a gene encoding a protein, “inactivation” means that the gene expression of the protein is reduced, and/or that the gene encodes an inactive protein or encodes a protein with reduced activity. Said inactivation, for example, may be due to an alteration in a promoter sequence such that the promoter is not capable of initiating transcription of the gene, to an alteration of a splicing site of an intron, which alteration interferes with correct splicing of the transcribed pre-mRNA, or an alteration in the coding region of the gene, rendering the encoded protein less active or even inactive. Said inactivation preferably is at least 50%, more preferably at least 60%, more preferably at least 70%, more preferably at least 80%, more preferably at least 90%, more preferably at least 99%, when compared to a not inactivated gene, meaning that a protein product of the gene has a maximal activity of at most 50%, more preferably at most 40%, more preferably at most 30%, more preferably at most 20%, more preferably at most 10%, more preferably at most 1%, of the wild type protein. This reduced activity may be due to reduced expression and/or a reduced activity of the protein encoded by an inactivated gene, when compared to the protein encoded by a wild type, i.e. a non-inactivated gene.

The term “hybrid” or “hybrid yeast”, as is used herein, refers to a yeast that is the result of combining genomes of two yeast of different varieties or species. A hybrid preferably is the result of sexual crossing, meaning that the hybrid yeast is the result of mating, also termed fusion, of two cells of different sex, such as two cells of different mating types, preferably of two gametes.

The term “interspecies hybrid”, as is used herein, refers to a yeast that is the result of combining genomes of two organisms of different species or even different genera.

The terms “yeast”, as is used herein, refer to eukaryotic, unicellular microorganisms that are classified as members of the kingdom fungus. A preferred yeast is a yeast of the Saccharomyces sensu stricto complex, including any hybrid thereof. The Saccharomyces sensu stricto complex currently encompasses eight different species: Saccharomyces cerevisiae, S. paradoxus, S. uvarum, S. mikatae, S. kudriavzevii, S. arboricola, S. eubayanus and the recently discovered S. jurei (Hittinger, 2013. Trends Genet 29:309-317; Naseeb et al., 2017. Int J Syst Evol Microbiol 67:2046-2052).

The term “fermentative yeast”, as is used herein, refers to a yeast of the Saccharomyces sensu stricto complex, preferably a S. cerevisiae or S. eubayanus yeast, and/or a hybrid thereof such as S. pastorianus, also termed S. carlsbergensis.

The term “sugar”, as is used herein, refers to sugar that is present in wort. These sugars include maltose, maltotriose, glucose, maltotetraose, sucrose, dextrin and fructose. In regular wort, maltose accounts for about 40-50% of the sugars, maltotriose and glucose each for about 5-15%, maltotetraose and sucrose each for about 4-5%, dextrins for about 20-25%, and fructose for about 2.5%. Of these sugars, maltotetraose and dextrins are considered non-fermentable.

The term “wort”, as is used herein, refers to an aqueous liquid extracted from mashed cereal grains. Said cereal grains comprise barley, or consist of barley. Starting wort, without added hop, may be termed “sweet wort”, while wort to which hop has been added may be termed “bitter wort”.

The term “maltose”, as is used herein, refers to a disaccharide consisting of two glucose molecules linked through an α-1,4 glycosidic bond.

The term “maltotriose”, as is used herein, refers to a trisaccharide consisting of three glucose molecules linked through α-1,4 glycosidic bonds.

The term “maltotetraose, as is used herein, refers to a tetrasaccharide ((2R,3R,4S,5S,6R)-2-[(2R,3S,4R,5R,6R)-6-[(2R,3S,4R,5R,6R)-4,5-dihydroxy-2-(hydroxymethyl)-6-[(2R,3S,4R,5R,6S)-4,5,6-trihydroxy-2-(hydroxymethyl) oxan-3-yl]oxyoxan-3-yl]oxy-4,5-dihydroxy-2-(hydroxymethyl) oxan-3-yl]oxy-6-(hydroxymethyl) oxane-3,4,5-triol), which is considered non-fermentable.

The term “dextrin”, as is used herein, refers to a mixture of polymers of D-glucose units linked by α-(1→4) or α-(1→6) glycosidic bonds. Dextrins are formed during degradation of starch by a series of alpha and beta amylases in the mashing process.

The term “substrate preference”, as is used herein, refers to the ability of a yeast strain to transport and metabolize a substrate. In the context of this application said substrate is a sugar, preferably selected from maltose, maltotriose fructose and glucose. A yeast can be selected for increased metabolic action towards a specific substrate, e.g. towards maltose, maltotriose, fructose or glucose, meaning that said specific substrate will be transported and metabolized with precedence, preferably even in the presence of other sugars, when compared to a reference yeast such as a parent yeast before selection. For example, a yeast strain that has a substrate preference for maltotriose will transport and metabolize maltotriose with precedence over maltose. A combination of at least two yeast strains that differ in their substrate preferences was found optimal, especially for fermenting high gravity wort. In addition, said combination of at least two yeast strains that differ in their substrate preferences resulted in enhanced attenuation of the resulting fermented beverage. In other words, said combination of at least two yeast strains that differ in their substrate preferences resulted in an apparent attenuation of the fermented beverage of at least 0.8, in a reduced time period, when compared to a single yeast strain, such as a single generalist or standard strain.

The term “maltose preference”, as is used herein, refers to a yeast strain that is able to transport and metabolize maltose with a higher preference, when compared to a parent strain. Said term preferably refers to a yeast that has a maltose/maltotriose rates ratio of 3 or more, preferably between 4 and 10 or higher.

The term “maltotriose preference”, as is used herein, refers to a yeast strain that is able to transport and metabolize maltotriose with a higher preference, when compared to a parent strain. Said term preferably refers to a yeast that has a maltose/maltotriose rates ratio of less than 2, preferably less than 1 such as between 0.01 and 1.

The term “generalist”, as is used herein, refers to a yeast strain that has no preference for conversion of maltose or maltotriose. Said term preferably refers to yeast that has a maltose/maltotriose rates ratio of between 1 and 4, preferably between 1.6 and 2.2, such as about 2.

The term “maltose rate”, as is used herein, refers to the rate of maltose fermentation by a yeast strain. Said rate is preferably determined in the exponential phase of a maltose consumption curve. Said rate is preferably determined by fitting a line with the formula Yₜ=Y₀*e^{(k1*t)}, wherein k1 (g L⁻¹ h⁻¹) is the rate constant, Yₜ (g L⁻¹) is the maltose concentration at time t, Y₀ (g L⁻¹) is the starting maltose concentration at t=0, and t (h) is time, to the points of the exponential phase of a maltose consumption curve. The constant k1 is the value calculated for a specific strain, or combination of strains.

The term “maltotriose rate”, as is used herein, refers to the rate of maltotriose fermentation by a yeast strain. Said rate is preferably determined in the exponential phase of a maltotriose consumption curve. Said rate is preferably determined by fitting a line with the formula Yₜ=Y₀*e (k2*t), wherein k2 (g L⁻¹ h⁻¹) is the rate constant, Yₜ (g L⁻¹) is the maltotriose concentration at time t, Y₀ (g L⁻¹) is the starting maltotriose concentration at t=0, and t (h) is time, to the points of the exponential phase of a maltotriose consumption curve. The constant k2 is the value calculated for a specific strain, or combination of strains.

The term “maltose/maltotriose rates ratio” refers to value of the determined maltose rate divided by the determined maltotriose rate (k1/k2), resulting in a dimension-less value maltose/maltotriose (M2/M3) rates ratio. Ratios may be maximized to a value of 10. Again, the constant k is the value calculated for a specific strain, or combination of strains.

The term “gravity”, as is used herein in the context of fermenting alcoholic beverages, refers to the relative density of a fluid, when compared to water, which largely depends on the sugar content of the fluid. Gravity may be determined by a hydrometer, refractometer, pycnometer or oscillating U-tube electronic meter, as is known to a person skilled in the art.

The term “specific gravity”, as is used herein, refers to the relative density of a fluid at a reference temperature, relative to the density of water at a reference temperature. It can be measured using either a hydrometer or refractometer with an appropriate scale.

The term “original extract”, as is used herein, refers to the mass in grams of sugars in 100 grams of wort, prior to fermentation, as measured in, for example, ° Plato, Brix, or dissolved solids scale. It can be measured directly on certain refractometers and hydrometers or converted from the original gravity.

The term “original gravity”, as is used herein, refers to a measure of specific gravity at a given reference temperature prior to fermentation. It can be measured directly on certain refractometers and hydrometers or converted from the original extract.

The term “extract”, as is used herein is a measure of the sum of fermentable sugars and nonfermentable soluble carbohydrates in a wort, whereby a solution with an extract of X ° Plato has the same density as a water solution containing X gram of sucrose in 100 g of solution.

The term “apparent extract”, as is used herein, refers to a portion of the original extract that is present as residual sugars which were not converted to yeast biomass, ethanol, or CO₂ during fermentation. It can be expressed interchangeably as ° Plato, Brix, or dissolved solids and is usually determined through calculations based on the original extract, without correction for the effect of ethanol on the density. Apparent extracts may be calculated from the densities, for example by the Analytica-EBC method 9.4 (EBC-European Brewery Convention. 2004. Analytica-EBC. Verlag Hans Carl Getränke-Fachverlag, Nuremberg, Germany).

The term “attenuation”, as is used herein, refers to the amount of the sugars that were present in the wort that have been converted via fermentation into CO₂ and alcohol and some other compounds like esters. Attenuation is preferably expressed in degrees Plato (° P), referring to the percentage of sugars that have been fermented when compared to the amount of sugars that were present at start.

The term “apparent attenuation”, as is used herein, refers to the relative conversion of sugars that were present in the starting wort, without correcting the effect of ethanol on the density. The apparent attenuation may be calculated by the formula: ([original extract-apparent extract]/original extract). The term “real attenuation” refers to relative conversion of sugars that were present in the starting wort, while correcting for the effect of ethanol on the density.

The term “final gravity”, as is used herein, refers to a measure of specific gravity, at a given reference temperature, at the conclusion of fermentation and is directly related to the apparent extract. Gravity readings can signal the end of fermentation when they stop moving. Final gravity can be measured directly on a hydrometer or calculated based on the original extract and the apparent extract.

The term “high gravity wort”, as is used herein, refers to a wort that has more than 14° Plato, preferably up to 23° Plato. Fermentation of a high gravity wort may result in a beer with at least 6% alcohol by volume (ABV).

4.2 Yeast Strains that Differ in their Hierarchical Substrate Preferences.

A yeast strain that has a preference for a sugar selected from maltose, maltotriose, fructose and glucose can be generated in multiple ways, as is known to a person skilled in the art. For example, said specialist may be naturally present and isolation of said specialist involves selection on, for example, synthetic growth medium comprising one of maltose, maltotriose, fructose and glucose as sole carbon source. Continuous selection on said selective growth medium, for example by reducing the concentration of the preferred sugar in order to force the yeast to adapt very efficient transport and metabolization routes for said sugar, may be performed in order to select a strain with preference for one of maltose, maltotriose, fructose and glucose.

However, said specialist may not be naturally present and isolation of said specialist may involve mutagenesis of a yeast strain, or of multiple yeast strains, prior to selection. Mutagenesis of a yeast, such as a Saccharomyces yeast, preferably a Saccharomyces sensu stricto yeast, can be performed using any method known in the art, including conventional random mutagenesis methods, such as radiation and chemical treatment, and recombinant DNA technologies, such as site-directed mutagenesis or targeted mutagenesis. Hence, the yeast cell may have been subjected to random mutagenesis, including treatment with UV irradiation, X-ray irradiation, gamma-ray irradiation and a mutagenic agent, or to genetic engineering.

The term “random mutagenesis” refers to mutagenesis techniques whereby the exact site of mutation is not predictable, and can occur anywhere in the chromosomes of the yeast cell(s) or spore(s). In general, these methods involve the use of chemical agents or radiation for inducing at least one mutation.

“Genetic engineering” is well known in the art and refers to altering the yeast's genome using biotechnological method, thereby introducing an alteration of the genomic DNA of the yeast, preferably at a predefined site and with a predefined alteration, termed site-directed mutagenesis.

Targeted mutagenesis, also termed site-directed mutagenesis, can be achieved using oligonucleotide-directed mutagenesis to generate site-specific mutations in a genomic DNA sequence of interest. Targeted mutagenesis refers to a mutagenesis method that alters a specific gene in vivo resulting in a change in the genetic structure directed at a specific site, such as by programmable RNA-guided nucleases, such as TALEN, CRISPR-Cas, zinc finger nuclease or meganuclease technology.

Said mutagenesis preferably is performed by subjecting a yeast to treatment with radiation, such as UV irradiation, X-ray irradiation, gamma-ray irradiation, and/or a mutagenic agent, preferably a chemical agent such as NTG (N-methyl-N′-nitro-N-nitrosoguanidine) or EMS (ethylmethanesulfonate). A particularly preferred mutagenesis procedure comprises UV irradiation, e.g. for 10 seconds to 3 minutes, preferably approximately 1-2 minutes. A preferred method includes exposure to UV light (TUV 30 W T8, Philips, Eindhoven, The Netherlands) at a radiation peak of 253.7 nm and for a period of 0.1 to 10 minutes, preferably 0.5-5 minutes, such as about 90 minutes.

Said mutagenesis may result in downmodulation or inactivation of one or more genes that are involved in uptake and/or metabolism of one or more sugars selected from glucose, maltose, fructose and maltotriose. For example, alteration of a cell surface glucose sensor Rgt2 and/or Snf3, and or of the downstream nuclear transcription factor Rgt1, result in the repression of genes that encode glucose transporters (Roy et al., 2016. Mol Biol Cell 27:862-871). Hence, mutation of one or more of Rgt2, Snf3, and Rgt1 may result in a mutant yeast strain that is unable to ferment glucose. Said mutant yeast strain will have a preference for a sugar selected from maltose and maltotriose.

Besides downmodulation or inactivation of one or more genes that are involved in uptake and/or metabolism of one or more sugars selected from glucose, fructose, maltose and maltotriose, said mutagenesis may result in the upregulation or activation of genes that encode key enzymes in uptake, fermentation and/or aerobic degradation of glucose, fructose, maltose and/or maltotriose. Said upregulation or activation may result in enhanced activity of, for example, a maltotriose transporter such that said mutant yeast cell may have a preference for a maltotriose.

It is preferred that said mutagenesis, preferably random mutagenesis, is performed in two or more rounds. Each round preferably includes a mutagenesis step, preferably a mild mutagenesis step, preferably a UV-mediated mutagenesis step, which results in a moderate survival rate of 20-60%, preferably 40-50%.

In a first round, the mutated yeasts may by inoculated in a synthetic medium containing one of the sugars glucose, maltose, fructose or maltotriose as the sole carbon source, preferably limited amounts of said sugar. This step will enrich for mutants that are able to efficiently consume at least one of glucose, fructose, maltose or maltotriose.

In a second round, the mutated yeasts that were positively selected on one of the sugars glucose, maltose, fructose or maltotriose, preferably on maltose or maltotriose, may by counter-selected by inoculation in a synthetic medium containing the two remaining sugars as the sole carbon source. A yeast that is not, or only hardly able to grow on the two remaining sugars may be selected for further analysis.

If necessary, a third round of mutagenesis may include growth on diluted brewer's wort that is enriched with one of the sugars glucose, fructose, maltose or maltotriose. Under these conditions, mutants with an improved affinity or a higher transport rate for said sugar would be less nutrient-limited, resulting in a selective advantage when compared to other yeasts. For this, wort may be diluted 2-10 times, for example six-fold. Said diluted wort may be supplemented with glucose, maltose, fructose or maltotriose, for example 1-20 g L⁻¹ such as 10 g L⁻¹ of glucose, maltose, fructose or maltotriose, to increase the relative concentration of glucose, maltose, fructose or maltotriose. Ergosterol, for example 1-100 mg L⁻¹, TWEEN® 80, for example 100-1000 mg L⁻¹, and ammonium sulfate, for example 1-20 mg L⁻¹, may be supplemented to prevent oxygen and nitrogen limitation.

Said growth on glucose, maltose, fructose or maltotriose-enriched brewer's wort is preferably performed by a continuous culture. Said continuous culture may be operated at a dilution rate of 0.001-0.2 h⁻¹, preferably at 0.01-0.1 h⁻¹ such as 0.03 h⁻¹. At a time point that glucose, fructose, maltose or maltotriose concentration decreases, single cells from the culture are preferably isolated, for example by FACS sorting. The isolated cells may be plated on synthetic medium containing glucose, fructose, maltose or maltotriose as the sole carbon source, and/or on brewer's wort that is enriched with glucose, maltose, fructose or maltotriose as is described herein above to further select Saccharomyces mutants that have preference for a sugar selected from maltose, maltotriose, fructose, and glucose.

If needed, a Saccharomyces mutant that has preference for a sugar selected from maltose, maltotriose, fructose and glucose may be counter-selected by growing said mutant in a medium or on a plate comprising one or more of the remaining sugars. A preferred Saccharomyces mutant will have preference for a particular sugar selected from maltose, maltotriose, fructose and glucose, but may show reduced growth on the other three sugars. Said reduced growth preferably is limited to less than 50% of a non-mutated Saccharomyces yeast, less than 25% of a non-mutated Saccharomyces yeast, less than 10% of a non-mutated Saccharomyces yeast or, most preferred, less than 5% of a non-mutated Saccharomyces yeast.

A Saccharomyces mutant that has preference for a sugar selected from maltose, maltotriose, fructose and glucose may be generated in a yeast strain that is subsequently hybridized to a second yeast strain comprising additional properties. For example, a Saccharomyces cerevisiae mutant may be generated, or may be selected without mutation, that has preference for fermenting maltose. Said mutant may be hybridized to a S. eubayanus strain that is not able to ferment glucose, fructose and/or maltotriose. A resulting interspecies hybrid may be selected that has preference for fermenting maltose, while said hybrid is not, or only hardly, able to ferment glucose, fructose and/or maltotriose.

Said fermentative yeast preferably comprises a mutation resulting in inactivation of at least one of the putative flavin prenyltransferase (PAD1) gene and ferulic acid decarboxylase (FDC1) gene, and/or inactivation of a gene encoding a protein involved in uptake of a phenolic acid, preferably ferulic acid, or involved in export of a decarboxylated phenolic compound, preferably 4-vinyl guaiacol. Said produced fermented beer product preferably is beer, preferably a lager beer.

4.3 Identification of a Saccharomyces Yeast with Different Sugar Consumption Characteristics.

A yeast strain that has a preference for a sugar selected from maltose, maltotriose, fructose and glucose can be generated in multiple ways, as is known to a person skilled in the art. For example, a culture medium, preferably a sterile culture medium, may be generated that comprises at least one of the sugars maltose, maltotriose, fructose and glucose. Said growth medium may be a natural growth medium, a synthetic growth medium, or a combination thereof.

Preferably, different culture media are generated, each comprising at least one of the sugars maltose, maltotriose, fructose and glucose. Growth of a specific Saccharomyces yeast strain on each sugar is subsequently determined, preferably the initial growth, more preferably the initial exponential growth. Said growth rate may be determined by determining the slope of the exponential growth curve, preferably the initial exponential growth curve. Methods for determining said slope are known in the art, including fitting the growth curve, preferably the exponential growth curve, to a formula X=X₀*e^{μτ}) wherein X₀ is the number of yeast at T=0, and μ is the growth rate, and determining a logarithm at time x. Said determined growth rate preferably is the maximal growth rate for growth of specific Saccharomyces yeast strain on each sugar.

As an alternative, or in addition, a growth medium comprising a combination of sugars is provided such as a wort. Said growth medium preferably comprises a specific amount of fermentable sugars, such as between 2 and 500 g/L, between 5 and 200 g/L, including 50 g/L, 75 g/L, 100 g/L, 120 g/L and 150 g/L of the sugars maltose, maltotriose, fructose and glucose. Following inoculation of said growth medium with a specific Saccharomyces yeast strain, samples are withdrawn from the growth medium at regular intervals, for example every 2 hours, every 5 hours, every 10 hours, every 12 hours, or once per day, for a period of time, for example for a period of between 1 day-2 weeks, including 1 week. Said sample may be analyzed for the number of yeast cells, for example by determining the OD₆₆₀, and for the amount of fermentable sugars and/or metabolites thereof. Said fermentable sugars preferably include maltose, maltotriose, fructose and glucose, preferably maltose, maltotriose and glucose, more preferably maltose and maltotriose.

Said preference preferably is determined by determining consumption rates for the individual sugars, including a maltose consumption rate, a maltotriose consumption rate, a glucose consumption rate and/or a fructose consumption rate. Said consumption rate is preferably determined in the exponential phase of a consumption curve for said fermentable sugar, for example by fitting an exponential curve of formula Y=Y₀*e^{(k*X)} to the points in the exponential phase of a consumption curve for each individual fermentable sugar.

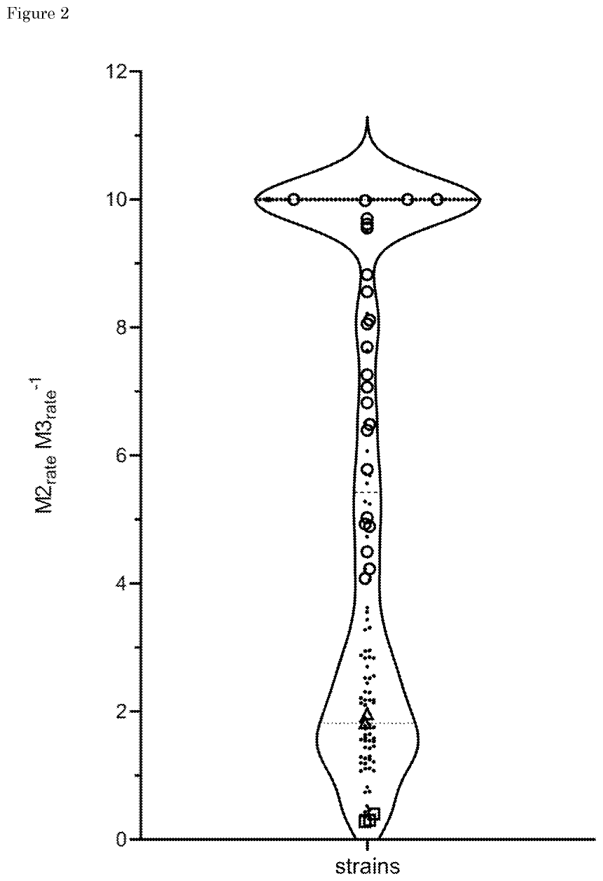

Said yeast strain preferably has a preference for maltose or for maltotriose. Said preference may be expressed in a dimension-less value maltose/maltotriose (M2/M3) rates ratio. Examples of M2/M3 rates ratio's for individual yeast strains are provided in Table 1 and in FIG. 2. M2/M3 rates ratio values ranged from 0.28 to the maximal value that was set at 10 across all samples. The maltose specialist S. pastorianus CBS 1483 showed M2/M3 rates ratio's ranging from 4 to 10. The maltotriose specialist Saccharomyces pastorianus CBS 1513 (alias NCYC396) showed M2/M3 rates ratio's ranging from 0.28 to 0.40. The generalist strain WS34/70 had M2/M3 rates ratio ranging from 1.82 to 1.96.

Hence, a yeast strain with maltose preference is able to transport and metabolize maltose with a higher preference, having a maltose/maltotriose rates ratio of 3 or more, preferably between 4 and 10 or higher. A yeast strain with maltotriose preference is able to transport and metabolize maltotriose with a higher preference, having a maltose/maltotriose rates ratio of less than 2, preferably less than 1 such as between 0.01 and 1. A generalist yeast strain has no preference for conversion of maltose or maltotriose, having a maltose/maltotriose rates ratio of between 1 and 4, preferably between 1.6 and 2.2, such as about 2.

A maltose/maltotriose rates ratio for an individual yeast strain can be determined without any inventive skills. As is shown in Table 1, said maltose/maltotriose rates ratio has been determined for a total of 139 individual yeast strains.

4.4 Methods of Producing a Fermented Beverage Using a Mixture of Saccharomyces Yeast with Different Specificities for Maltose, Maltotriose, Fructose and/or Glucose.

Yeasts have been used since long in baking, brewing and distilling, such as in bread production and beer and wine fermentation. Methods of the invention will enable better mixed-sugar fermentation kinetics than application of a single generalist strain resulting in improved final attenuation and ethanol yields.

The methods of the invention comprise the provision of mashed cereal grains, preferably barley, in an aqueous solution, preferably in water, to release the malt sugars. This malting step is followed by boiling the resulting wort in the presence of bop, and fermenting the resulting boiled wort after cooling. When fermentation is completed, the beer may be filtered and bottled. A skilled person is aware that complete fermentation of a beer such as a lager beer may take up to 6 weeks, depending on e.g. the temperature and the yeast starting culture.

During the fermentation process, fermentable sugars are converted into alcohols such as ethanol, CO₂ and flavor compounds such as esters, for example isoamyl acetate. As is known to a person skilled in the art, factors that will influence the appearance and taste of the resulting product include, but are not limited to, roasting temperature and roasting time of the grains, temperature and time of steeping, germination, and kilning of the grains, temperature and time of milling and mashing of the grains, lautering of the resulting mash to generate the wort, temperature and time of boiling of the wort, timing and amounts of added hop, the specific hop that is used, temperature and time of fermentation, type of yeast, mechanically filtering of the yeast or the addition of filtering agents to remove the yeast and, finally, carbonating and packaging of the beer. During a conditioning step, which may start after fermentation but before filtering, the yeast is given time, from days to weeks, to absorb common off flavors associated with under-conditioned or “green” beer, including sulfur, butter, and green apples.

In the methods of the invention, the fermentation process is performed at normal temperatures, preferably below 30° C., such as 6-25° C. 6-24° C., 6-23° C., 6-22° C., 6.21° C. 6.20° C., 6-19° C., 6-18° C., 6-17° C., 6-16° C., 6-15° C., 6-14° C., more preferably 8-13° C., including 9° C., 10° C., 11° C., and 12° C. Lager beer fermentation is generally performed at temperatures between 7-13° C. The temperature may depend on the specific yeast strains that are used in the fermentation process, as is known to a person skilled in the art.

Methods of the invention preferably employ a combination of yeast strains that have different specificities for fermenting maltose, maltotriose, fructose and/or glucose that are present in wort, into ethanol. Said combination of yeast strains preferably encompasses naturally occurring yeasts of Saccharomyces sensu stricto, preferably of S. cerevisiae, S. carlsbergensis, S. pastorianus, S. eubayanus yeast, and/or hybrids thereof, or of mutants from Saccharomyces sensu stricto, preferably of S. cerevisiae, S. carlsbergensis, S. pastorianus, S. eubayanus yeast, and/or hybrids thereof.

Each of said yeast strains has been selected for enhanced preference for fermenting one of maltose, fructose, maltotriose and glucose over the other two sugars. A preferred yeast is a S. pastorianus yeast, preferably a naturally occurring S. pastorianus yeast such as S. pastorianus strain CBS 1483, S. pastorianus strain CBS 1513, or a combination of S. pastorianus strain CBS 1483 and S. pastorianus strain CBS 1513.

A maltotriose specialist may be selected from CBS 1513, NCYC 452, NCYC 1269, NCYC 451, NCYC 457, NCYC 204, NCYC 185, NCYC 1239, NCYC 1146, NCYC 1297, NCYC 1073, NCYC 231, NCYC 1305, CBS 6903, NCYC 203, CBS 2443, NCYC 2339, NCYC 1324, CBS 2898, CBS 7240, NCYC 1526, NCYC 1544, NCYC 2359, NCYC 986, NCYC 1295, NCYC 1516, NCYC 1326, NCYC 2398, NCYC 669, and NCYC 2921.

A maltose specialist, may be selected from NCYC 1262, NCYC 227, NCYC 699, NCYC 487, NCYC 2340, NCYC 1296, NCYC 228, NCYC 584, NCYC 2801. NCYC 1365, NCYC 668, NCYC 450, NCYC 1236, NCYC 75, NCYC 112, NCYC 115, NCYC 177, NCYC 223, NCYC 224, NCYC 240, NCYC 340, NCYC 478, NCYC 479, NCYC 510, NCYC 530, NCYC 965, NCYC 969, NCYC 976, NCYC 987, NCYC 989. NCYC 1322, NCYC 1323, NCYC 229, NCYC 230, NCYC 242, NCYC 392, NCYC 397, NCYC 398, NCYC 511, NCYC 584, NCYC 3420, CBS 12357, CBS 7001, CBS 1174, CBS 1177, CBS 1246, CBS 1386. CBS 1488, CBS 1502, CBS 1504, CBS 1548, CBS 1550, CBS 1551, CBS 1552, CBS 1603, CBS 1605, CBS 1606, CBS 1608, CBS 1665, CBS 2165, CBS 2442, CBS 2945, CBS 2954, CBS 2986, CBS 5156, CBS 6017, yHDPN 421, yHKS 210, yHKS 212, yHKS 509, yHRVM 107, NCYC 966, and CBS 1483.

A combination of yeast may include any one of CBS 1513, NCYC 452, NCYC 1269, NCYC 451, NCYC 457, and NCYC 204, having the lowest, M2rate/M3rate ratio, and any one of NCYC 75, NCYC 112, NCYC 115, NCYC 177, NCYC 223, NCYC 224, NCYC 240, NCYC 340, NCYC 478, NCYC 479, NCYC 510, NCYC 530, NCYC 965, NCYC 969, NCYC 975, NCYC 987, NCYC 989, NCYC 1322, NCYC 1323, NCYC 229, NCYC 230, NCYC 242, NCYC 392, NCYC 397, NCYC 398, NCYC 511, NCYC 584, NCYC 3420, CBS 12357, CBS 7001, CBS 1174, CBS 1177, CBS 1245, CBS 1386, CBS 1488, CBS 1502, CBS 1504, CBS 1548, CBS 1550, CBS 1551, CBS 1552, CBS 1603, CBS 1605, CBS 1606, CBS 1608, CBS 1665, CBS 2165, CBS 2442, CBS 2945, CBS 2954, CBS 2986, CBS 6156, CBS 6017, yHDPN 421, yHKS 210, yHKS 212, yHKS 509, yHRVM 107, NCYC 966, and CBS 1483, having the highest M2rate/M3rate ratio.

Said combination of yeast may include any one of CBS 1513, NCYC 452, NCYC 1269, NCYC 451, NCYC 457, and NCYC 204, having the lowest M2rate/M3rate ratio, and any one of the generalist strains NCYC 984, NCYC 529, NCYC 2347, NCYC 2837, NCYC 670, NCYC 2426, NCYC 531, WS34/70, NCYC 454, NCYC 73, NCYC 2337, NCYC 1250, NCYC 1056, NCYC 456, NCYC 985, NCYC 680, NCYC 2338, NCYC 1026, CBS 1484, CBS 5832, NCYC 1341, CMB S33, NCYC 399, NCYC 1342, NCYC 400, NCYC 3419, NCYC 1048, NCYC 1116, NCYC 55, NCYC 453, NCYC 1057, NCYC 1047, CBS 8834, NCYC 967, and NCYC 679.

Said combination of yeast may include any one of NCYC 75, NCYC 112, NCYC 115, NCYC 177, NCYC 223, NCYC 224, NCYC 240, NCYC 340, NCYC 478, NCYC 479, NCYC 510, NCYC 530, NCYC 965, NCYC 969, NCYC 975, NCYC 987, NCYC 989, NCYC 1322, NCYC 1323, NCYC 229, NCYC 230, NCYC 242, NCYC 392, NCYC 397, NCYC 398, NCYC 511, NCYC 684, NCYC 3420, CBS 12357, CBS 7001, CBS 1174, CBS 1177, CBS 1245, CBS 1386, CBS 1488, CBS 1502, CBS 1504, CBS 1648, CBS 1550, CBS 1561, CBS 1552. CBS 1603, CBS 1605, CBS 1606, CBS 1608, CBS 1665, CBS 2165, CBS 2442, CBS 2946, CBS 2954, CBS 2986, CBS 5156, CBS 6017, yHDPN 421, yHKS 210, yHKS 212, yHKS 509, yHRVM 107, NCYC 966, and CBS 1483, having the highest M2rate/M3rate ratio, and any one of the generalist strains NCYC 984, NCYC 529, NCYC 2347, NCYC 2837, NCYC 670, NCYC 2426, NCYC 531, WS34/70, NCYC 454, NCYC 73, NCYC 2337, NCYC 1250, NCYC 1056, NCYC 456, NCYC 985, NCYC 680, NCYC 2338, NCYC 1026, CBS 1484, CBS 5832, NCYC 1341, CMB S33, NCYC 399, NCYC 1342, NCYC 400, NCYC 3419, NCYC 1048, NCYC 1116, NCYC 55, NCYC 453, NCYC 1057, NCYC 1047, CBS 8834, NCYC 967, and NCYC 679.

Said combination preferably is selected from CBS 1613 and NCYC 1262, CBS 1513 and NCYC 227, CBS 1513 and NCYC 699, CBS 1513 and NCYC 487, CBS 1513 and NCYC 2340, CBS 1513 and NCYC 1296, CBS 1513 and NCYC 228, CBS 1513 and NCYC 534, CBS 1518 and NCYC 2801, CBS 1513 and NCYC 1365, CBS 1513 and NCYC 668, CBS 1513 and NCYC 450, CBS 1513 and NCYC 1236, CBS 1513 and NCYC 76, CBS 1513 and NCYC 112, CBS 1513 and NCYC 115, CBS 1513 and NCYC 177, CBS 1513 and NCYC 223, CBS 1513 and NCYC 224, CBS 1513 and NCYC 240, CBS 1513 and NCYC 340, CBS 1513 and NCYC 478, CBS 1513 and NCYC 479, CBS 1513 and NCYC 510, CBS 1513 and NCYC 530. CBS 1513 and NCYC 965, CBS 1513 and NCYC 969, CBS 1513 and NCYC 975, CBS 1513 and NCYC 987, CBS 1513 and NCYC 989, CBS 1513 and NCYC 1322, CBS 1513 and NCYC 1323, CBS 1513 and NCYC 229, CBS 1513 and NCYC 230, CBS 1513 and NCYC 242, CBS 1513 and NCYC 392, CBS 1513 and NCYC 397, CBS 1513 and NCYC 398, CBS 1513 and NCYC 611, CBS 1513 and NCYC 584, CBS 1513 and NCYC 3420, CBS 1513 and CBS 12357, CBS 1513 and CBS 7001, CBS 1613 and CBS 1174, CBS 1518 and CBS 1177. CBS 1513 and CBS 1245, CBS 1513 and CBS 1386, CBS 1513 and CBS 1488, CBS 1513 and CBS 1502, CBS 1513 and CBS 1604, CBS 1513 and CBS 1548, CBS 1513 and CBS 1550, CBS 1513 and CBS 1651, CBS 1513 and CBS 1562, CBS 1513 and CBS 1603, CBS 1513 and CBS 1605. CBS 1513 and CBS 1606, CBS 1513 and CBS 1608, CBS 1513 and CBS 1665, CBS 1513 and CBS 2165, CBS 1513 and CBS 2442, CBS 1613 and CBS 2945, CBS 1513 and CBS 2954, CBS 1513 and CBS 2986, CBS 1513 and CBS 5156, CBS 1513 and CBS 6017, CBS 1513 and yHDPN 421, CBS 1513 and yHKS 210, CBS 1513 and yHKS 212, CBS 1513 and yHKS 509, CBS 1513 and yHRVM 107, CBS 1513 and NCYC 966, and CBS 1513 and CBS 1483; NCYC 452 and NCYC 1262, NCYC 452 and NCYC 227, NCYC 452 and NCYC 699, NCYC 452 and NCYC 487, NCYC 452 and NCYC 2340, NCYC 452 and NCYC 1296, NCYC 452 and NCYC 228, NCYC 452 and NCYC 534, NCYC 462 and NCYC 2801, NCYC 452 and NCYC 1365, NCYC 452 and NCYC 668, NCYC 452 and NCYC 450, NCYC 452 and NCYC 1236, NCYC 452 and NCYC 75, NCYC 452 and NCYC 112, NCYC 452 and NCYC 115. NCYC 462 and NCYC 177, NCYC 452 and NCYC 223, NCYC 452 and NCYC 224, NCYC 452 and NCYC 240, NCYC 452 and NCYC 340, NCYC 452 and NCYC 478, NCYC 452 and NCYC 479, NCYC 452 and NCYC 510, NCYC 452 and NCYC 580, NCYC 452 and NCYC 965, NCYC 452 and NCYC 969, NCYC 452 and NCYC 975, NCYC 452 and NCYC 987, NCYC 452 and NCYC 989, NCYC 452 and NCYC 1322. NCYC 452 and NCYC 1323, NCYC 452 and NCYC 229, NCYC 452 and NCYC 230, NCYC 452 and NCYC 242, NCYC 452 and NCYC 392, NCYC 452 and NCYC 397, NCYC 452 and NCYC 398, NCYC 452 and NCYC 511, NCYC 452 and NCYC 584, NCYC 452 and NCYC 3420, NCYC 452 and CBS 12357, NCYC 452 and CBS 7001, NCYC 452 and CBS 1174, NCYC 452 and CBS 1177, NCYC 452 and CBS 1245. NCYC 452 and CBS 1386, NCYC 452 and CBS 1488, NCYC 452 and CBS 1502, NCYC 452 and CBS 1504, NCYC 452 and CBS 1548, NCYC 452 and CBS 1550, NCYC 452 and CBS 1551, NCYC 452 and CBS 1552, NCYC 452 and CBS 1603, NCYC 452 and CBS 1605, NCYC 452 and CBS 1606, NCYC 452 and CBS 1608, NCYC 452 and CBS 1665, NCYC 452 and CBS 2165, NCYC 452 and CBS 2442, NCYC 452 and CBS 2945, NCYC 452 and CBS 2954, NCYC 452 and CBS 2986, NCYC 452 and CBS 5156, NCYC 452 and CBS 6017, NCYC 452 and yHDPN 421, NCYC 452 and yHEKS 210, NCYC 452 and yHKS 212, NCYC 452 and yHKS 509. NCYC 452 and yHRVM 107, NCYC 452 and NCYC 966, and NCYC 462 and CBS 1483; NCYC 1269 and NCYC 1262, NCYC 1269 and NCYC 227, NCYC 1269 and NCYC 699, NCYC 1269 and NCYC 487, NCYC 1269 and NCYC 2340, NCYC 1269 and NCYC 1296, NCYC 1269 and NCYC 228, NCYC 1269 and NCYC 534, NCYC 1269 and NCYC 2801, NCYC 1269 and NCYC 1365, NCYC 1269 and NCYC 668, NCYC 1269 and NCYC 450, NCYC 1269 and NCYC 1236, NCYC 1269 and NCYC 76, NCYC 1269 and NCYC 112, NCYC 1269 and NCYC 116, NCYC 1269 and NCYC 177, NCYC 1269 and NCYC 223, NCYC 1269 and NCYC 224, NCYC 1269 and NCYC 240, NCYC 1269 and NCYC 340, NCYC 1269 and NCYC 478, NCYC 1269 and NCYC 479, NCYC 1269 and NCYC 610, NCYC 1269 and NCYC 530, NCYC 1269 and NCYC 965, NCYC 1269 and NCYC 969, NCYC 1269 and NCYC 975, NCYC 1269 and NCYC 987, NCYC 1269 and NCYC 989, NCYC 1269 and NCYC 1322, NCYC 1269 and NCYC 1323, NCYC 1269 and NCYC 229, NCYC 1269 and NCYC 230, NCYC 1269 and NCYC 242, NCYC 1269 and NCYC 392, NCYC 1269 and NCYC 397, NCYC 1269 and NCYC 398, NCYC 1269 and NCYC 511, NCYC 1269 and NCYC 584, NCYC 1269 and NCYC 3420, NCYC 1269 and CBS 12357, NCYC 1269 and CBS 7001, NCYC 1269 and CBS 1174, NCYC 1269 and CBS 1177, NCYC 1269 and CBS 1245, NCYC 1269 and CBS 1386, NCYC 1269 and CBS 1488, NCYC 1269 and CBS 1502, NCYC 1269 and CBS 1504, NCYC 1269 and CBS 1548, NCYC 1269 and CBS 1550, NCYC 1269 and CBS 1551, NCYC 1269 and CBS 1662, NCYC 1269 and CBS 1603, NCYC 1269 and CBS 1606, NCYC 1269 and CBS 1606, NCYC 1269 and CBS 1608, NCYC 1269 and CBS 1666, NCYC 1269 and CBS 2165, NCYC 1269 and CBS 2442, NCYC 1269 and CBS 2945, NCYC 1269 and CBS 2954, NCYC 1269 and CBS 2986, NCYC 1269 and CBS 6166, NCYC 1269 and CBS 6017, NCYC 1269 and yHDPN 421, NCYC 1269 and yHKS 210, NCYC 1269 and yHKS 212, NCYC 1269 and yHKS 509, NCYC 1269 and yHRVM 107, NCYC 1269 and NCYC 966, and NCYC 1269 and CBS 1483; NCYC 451 and NCYC 1262, NCYC 451 and NCYC 227, NCYC 451 and NCYC 699, NCYC 451 and NCYC 487, NCYC 451 and NCYC 2340, NCYC 451 and NCYC 1296, NCYC 451 and NCYC 228, NCYC 451 and NCYC 534, NCYC 451 and NCYC 2801, NCYC 451 and NCYC 1365, NCYC 451 and NCYC 668, NCYC 451 and NCYC 450, NCYC 451 and NCYC 1236, NCYC 451 and NCYC 75, NCYC 451 and NCYC 112, NCYC 451 and NCYC 115, NCYC 451 and NCYC 177, NCYC 451 and NCYC 223, NCYC 451 and NCYC 224, NCYC 451 and NCYC 240, NCYC 451 and NCYC 340, NCYC 451 and NCYC 478, NCYC 451 and NCYC 479, NCYC 451 and NCYC 510, NCYC 451 and NCYC 530, NCYC 451 and NCYC 965, NCYC 451 and NCYC 969, NCYC 451 and NCYC 975, NCYC 451 and NCYC 987, NCYC 451 and NCYC 989, NCYC 451 and NCYC 1322, NCYC 451 and NCYC 1323, NCYC 451 and NCYC 229, NCYC 451 and NCYC 230, NCYC 451 and NCYC 242, NCYC 451 and NCYC 392, NCYC 451 and NCYC 397, NCYC 451 and NCYC 398, NCYC 451 and NCYC 611, NCYC 461 and NCYC 584, NCYC 451 and NCYC 3420, NCYC 451 and CBS 12357, NCYC 451 and CBS 7001, NCYC 451 and CBS 1174, NCYC 451 and CBS 1177, NCYC 451 and CBS 1245, NCYC 451 and CBS 1386, NCYC 451 and CBS 1488, NCYC 451 and CBS 1502, NCYC 451 and CBS 1504, NCYC 451 and CBS 1548, NCYC 451 and CBS 1650, NCYC 451 and CBS 1551, NCYC 451 and CBS 1552, NCYC 451 and CBS 1603, NCYC 451 and CBS 1606, NCYC 451 and CBS 1606, NCYC 451 and CBS 1608, NCYC 451 and CBS 1665, NCYC 451 and CBS 2165, NCYC 451 and CBS 2442, NCYC 451 and CBS 2945, NCYC 451 and CBS 2954, NCYC 451 and CBS 2986, NCYC 451 and CBS 6156, NCYC 451 and CBS 6017, NCYC 451 and yHDPN 421, NCYC 451 and yHKS 210, NCYC 451 and yHKS 212, NCYC 451 and yHKS 509, NCYC 451 and yHRVM 107, NCYC 451 and NCYC 966, and NCYC 451 and CBS 1483:

NCYC 467 and NCYC 1262, NCYC 457 and NCYC 227, NCYC 457 and NCYC 699, NCYC 457 and NCYC 487, NCYC 457 and NCYC 2340, NCYC 457 and NCYC 1296, NCYC 457 and NCYC 228, NCYC 457 and NCYC 534, NCYC 457 and NCYC 2801, NCYC 457 and NCYC 1365, NCYC 457 and NCYC 668, NCYC 457 and NCYC 450, NCYC 457 and NCYC 1236, NCYC 457 and NCYC 75, NCYC 457 and NCYC 112, NCYC 457 and NCYC 115, NCYC 457 and NCYC 177, NCYC 457 and NCYC 223, NCYC 457 and NCYC 224, NCYC 457 and NCYC 240, NCYC 457 and NCYC 340, NCYC 457 and NCYC 478, NCYC 457 and NCYC 479, NCYC 457 and NCYC 610, NCYC 457 and NCYC 530, NCYC 457 and NCYC 965, NCYC 457 and NCYC 969, NCYC 457 and NCYC 975, NCYC 457 and NCYC 987, NCYC 457 and NCYC 989, NCYC 457 and NCYC 1322, NCYC 457 and NCYC 1323, NCYC 457 and NCYC 229, NCYC 467 and NCYC 230, NCYC 457 and NCYC 242, NCYC 457 and NCYC 392, NCYC 457 and NCYC 397, NCYC 457 and NCYC 398, NCYC 467 and NCYC 511, NCYC 457 and NCYC 584, NCYC 457 and NCYC 3420, NCYC 457 and CBS 12367, NCYC 457 and CBS 7001, NCYC 457 and CBS 1174, NCYC 457 and CBS 1177, NCYC 457 and CBS 1246, NCYC 457 and CBS 1386, NCYC 457 and CBS 1488, NCYC 457 and CBS 1502, NCYC 457 and CBS 1504, NCYC 457 and CBS 1548, NCYC 457 and CBS 1550, NCYC 457 and CBS 1651, NCYC 457 and CBS 1652, NCYC 457 and CBS 1603, NCYC 457 and CBS 1605, NCYC 457 and CBS 1606, NCYC 457 and CBS 1608, NCYC 457 and CBS 1665, NCYC 457 and CBS 2166, NCYC 467 and CBS 2442, NCYC 457 and CBS 2945, NCYC 457 and CBS 2954, NCYC 457 and CBS 2986, NCYC 457 and CBS 5156, NCYC 457 and CBS 6017, NCYC 457 and yHDPN 421, NCYC 457 and yHKS 210, NCYC 457 and yHKS 212, NCYC 457 and yHKS 609, NCYC 457 and yHRVM 107, NCYC 457 and NCYC 966, and NCYC 457 and CBS 1483: NCYC 204 and NCYC 1262, NCYC 204 and NCYC 227, NCYC 204 and NCYC 699, NCYC 204 and NCYC 487, NCYC 204 and NCYC 2340, NCYC 204 and NCYC 1296, NCYC 204 and NCYC 228. NCYC 204 and NCYC 534, NCYC 204 and NCYC 2801, NCYC 204 and NCYC 1365, NCYC 204 and NCYC 668, NCYC 204 and NCYC 450, NCYC 204 and NCYC 1236, NCYC 204 and NCYC 75, NCYC 204 and NCYC 112, NCYC 204 and NCYC 115, NCYC 204 and NCYC 177, NCYC 204 and NCYC 223, NCYC 204 and NCYC 224, NCYC 204 and NCYC 240, NCYC 204 and NCYC 340, NCYC 204 and NCYC 478, NCYC 204 and NCYC 479, NCYC 204 and NCYC 510, NCYC 204 and NCYC 530, NCYC 204 and NCYC 965, NCYC 204 and NCYC 969, NCYC 204 and NCYC 975, NCYC 204 and NCYC 987, NCYC 204 and NCYC 989, NCYC 204 and NCYC 1322, NCYC 204 and NCYC 1323, NCYC 204 and NCYC 229, NCYC 204 and NCYC 230, NCYC 204 and NCYC 242, NCYC 204 and NCYC 392, NCYC 204 and NCYC 397, NCYC 204 and NCYC 398, NCYC 204 and NCYC 511, NCYC 204 and NCYC 684, NCYC 204 and NCYC 3420, NCYC 204 and CBS 12357, NCYC 204 and CBS 7001, NCYC 204 and CBS 1174, NCYC 204 and CBS 1177, NCYC 204 and CBS 1245, NCYC 204 and CBS 1386, NCYC 204 and CBS 1488, NCYC 204 and CBS 1502, NCYC 204 and CBS 1504, NCYC 204 and CBS 1548, NCYC 204 and CBS 1550, NCYC 204 and CBS 1551, NCYC 204 and CBS 1552, NCYC 204 and CBS 1603, NCYC 204 and CBS 1605, NCYC 204 and CBS 1606, NCYC 204 and CBS 1608, NCYC 204 and CBS 1665, NCYC 204 and CBS 2165, NCYC 204 and CBS 2442, NCYC 204 and CBS 2945, NCYC 204 and CBS 2954, NCYC 204 and CBS 2986, NCYC 204 and CBS 5156, NCYC 204 and CBS 6017, NCYC 204 and yHDPN 421, NCYC 204 and yHKS 210, NCYC 204 and yHKS 212, NCYC 204 and yHKS 509, NCYC 204 and yHRVM 107, NCYC 204 and NCYC 966, and NCYC 204 and CBS 1483; NCYC 185 and NCYC 1262, NCYC 185 and NCYC 227, NCYC 185 and NCYC 699, NCYC 185 and NCYC 487, NCYC 185 and NCYC 2340, NCYC 185 and NCYC 1296, NCYC 185 and NCYC 228, NCYC 185 and NCYC 584, NCYC 186 and NCYC 2801, NCYC 185 and NCYC 1365, NCYC 185 and NCYC 668, NCYC 185 and NCYC 450, NCYC 185 and NCYC 1236, NCYC 185 and NCYC 75, NCYC 185 and NCYC 112, NCYC 185 and NCYC 116, NCYC 185 and NCYC 177, NCYC 185 and NCYC 223, NCYC 185 and NCYC 224, NCYC 185 and NCYC 240, NCYC 185 and NCYC 340, NCYC 185 and NCYC 478, NCYC 185 and NCYC 479, NCYC 185 and NCYC 610, NCYC 185 and NCYC 530, NCYC 185 and NCYC 965, NCYC 185 and NCYC 969, NCYC 185 and NCYC 975, NCYC 185 and NCYC 987, NCYC 185 and NCYC 989, NCYC 185 and NCYC 1322, NCYC 185 and NCYC 1323. NCYC 185 and NCYC 229, NCYC 185 and NCYC 230, NCYC 185 and NCYC 242, NCYC 185 and NCYC 392, NCYC 185 and NCYC 397, NCYC 185 and NCYC 398, NCYC 185 and NCYC 511, NCYC 185 and NCYC 584, NCYC 185 and NCYC 3420, NCYC 185 and CBS 12357, NCYC 185 and CBS 7001, NCYC 185 and CBS 1174, NCYC 185 and CBS 1177, NCYC 185 and CBS 1245, NCYC 185 and CBS 1386, NCYC 185 and CBS 1488, NCYC 185 and CBS 1502, NCYC 185 and CBS 1504, NCYC 185 and CBS 1548, NCYC 185 and CBS 1560, NCYC 186 and CBS 1651. NCYC 185 and CBS 1552, NCYC 185 and CBS 1603, NCYC 185 and CBS 1605, NCYC 185 and CBS 1606, NCYC 185 and CBS 1608, NCYC 185 and CBS 1665, NCYC 185 and CBS 2165, NCYC 185 and CBS 2442, NCYC 185 and CBS 2946, NCYC 185 and CBS 2954, NCYC 185 and CBS 2986, NCYC 185 and CBS 6156, NCYC 185 and CBS 6017, NCYC 185 and yHDPN 421, NCYC 185 and yHKS 210. NCYC 185 and yHKS 212, NCYC 185 and yHKS 509, NCYC 185 and yHRVM 107, NCYC 185 and NCYC 966, and NCYC 185 and CBS 1483; NCYC 1239 and NCYC 1262, NCYC 1239 and NCYC 227, NCYC 1239 and NCYC 699, NCYC 1239 and NCYC 487, NCYC 1239 and NCYC 2340, NCYC 1239 and NCYC 1296, NCYC 1239 and NCYC 228, NCYC 1239 and NCYC 534, NCYC 1239 and NCYC 2801, NCYC 1239 and NCYC 1365, NCYC 1239 and NCYC 668, NCYC 1239 and NCYC 450, NCYC 1239 and NCYC 1236, NCYC 1239 and NCYC 76, NCYC 1239 and NCYC 112, NCYC 1239 and NCYC 115, NCYC 1239 and NCYC 177, NCYC 1239 and NCYC 223, NCYC 1239 and NCYC 224, NCYC 1239 and NCYC 240, NCYC 1239 and NCYC 340, NCYC 1239 and NCYC 478, NCYC 1239 and NCYC 479, NCYC 1239 and NCYC 510, NCYC 1239 and NCYC 530, NCYC 1239 and NCYC 965. NCYC 1239 and NCYC 969, NCYC 1239 and NCYC 975, NCYC 1239 and NCYC 987, NCYC 1239 and NCYC 989, NCYC 1239 and NCYC 1322, NCYC 1239 and NCYC 1323, NCYC 1239 and NCYC 229, NCYC 1239 and NCYC 230, NCYC 1239 and NCYC 242, NCYC 1239 and NCYC 392, NCYC 1239 and NCYC 397, NCYC 1239 and NCYC 398, NCYC 1239 and NCYC 611, NCYC 1239 and NCYC 584, NCYC 1239 and NCYC 3420, NCYC 1239 and CBS 12357, NCYC 1239 and CBS 7001, NCYC 1239 and CBS 1174, NCYC 1239 and CBS 1177, NCYC 1239 and CBS 1245, NCYC 1239 and CBS 1386, NCYC 1239 and CBS 1488, NCYC 1239 and CBS 1502, NCYC 1239 and CBS 1504, NCYC 1239 and CBS 1548, NCYC 1239 and CBS 1550, NCYC 1239 and CBS 1551, NCYC 1239 and CBS 1552, NCYC 1239 and CBS 1603, NCYC 1239 and CBS 1605, NCYC 1239 and CBS 1606, NCYC 1239 and CBS 1608, NCYC 1239 and CBS 1665, NCYC 1239 and CBS 2165, NCYC 1239 and CBS 2442, NCYC 1239 and CBS 2945, NCYC 1239 and CBS 2954, NCYC 1239 and CBS 2986, NCYC 1239 and CBS 5156, NCYC 1239 and CBS 6017, NCYC 1239 and yHDPN 421, NCYC 1239 and yHKS 210, NCYC 1239 and yHKS 212, NCYC 1239 and yHKS 509, NCYC 1239 and yHRVM 107, NCYC 1239 and NCYC 966, and NCYC 1239 and CBS 1483; NCYC 1146 and NCYC 1262, NCYC 1146 and NCYC 227, NCYC 1146 and NCYC 699, NCYC 1146 and NCYC 487, NCYC 1146 and NCYC 2340, NCYC 1146 and NCYC 1296, NCYC 1146 and NCYC 228, NCYC 1146 and NCYC 534, NCYC 1146 and NCYC 2801, NCYC 1146 and NCYC 1365, NCYC 1146 and NCYC 668, NCYC 1146 and NCYC 450, NCYC 1146 and NCYC 1236, NCYC 1146 and NCYC 75, NCYC 1146 and NCYC 112, NCYC 1146 and NCYC 115, NCYC 1146 and NCYC 177, NCYC 1146 and NCYC 223, NCYC 1146 and NCYC 224, NCYC 1146 and NCYC 240, NCYC 1146 and NCYC 340, NCYC 1146 and NCYC 478, NCYC 1146 and NCYC 479, NCYC 1146 and NCYC 510, NCYC 1146 and NCYC 530, NCYC 1146 and NCYC 965, NCYC 1146 and NCYC 969, NCYC 1146 and NCYC 975, NCYC 1146 and NCYC 987, NCYC 1146 and NCYC 989, NCYC 1146 and NCYC 1322, NCYC 1146 and NCYC 1323, NCYC 1146 and NCYC 229, NCYC 1146 and NCYC 230, NCYC 1146 and NCYC 242, NCYC 1146 and NCYC 392, NCYC 1146 and NCYC 397, NCYC 1146 and NCYC 398, NCYC 1146 and NCYC 511, NCYC 1146 and NCYC 584, NCYC 1146 and NCYC 3420, NCYC 1146 and CBS 12357, NCYC 1146 and CBS 7001, NCYC 1146 and CBS 1174, NCYC 1146 and CBS 1177, NCYC 1146 and CBS 1245, NCYC 1146 and CBS 1386, NCYC 1146 and CBS 1488, NCYC 1146 and CBS 1502, NCYC 1146 and CBS 1604, NCYC 1146 and CBS 1548, NCYC 1146 and CBS 1550, NCYC 1146 and CBS 1551, NCYC 1146 and CBS 1562, NCYC 1146 and CBS 1603, NCYC 1146 and CBS 1605, NCYC 1146 and CBS 1606, NCYC 1146 and CBS 1608, NCYC 1146 and CBS 1665, NCYC 1146 and CBS 2165, NCYC 1146 and CBS 2442, NCYC 1146 and CBS 2945, NCYC 1146 and CBS 2954, NCYC 1146 and CBS 2986, NCYC 1146 and CBS 5156, NCYC 1146 and CBS 6017, NCYC 1146 and yHDPN 421, NCYC 1146 and yHKS 210, NCYC 1146 and yHKS 212, NCYC 1146 and yHKS 509, NCYC 1146 and yHRVM 107, NCYC 1146 and NCYC 966, and NCYC 1146 and CBS 1483; NCYC 1297 and NCYC 1262, NCYC 1297 and NCYC 227, NCYC 1297 and NCYC 699, NCYC 1297 and NCYC 487, NCYC 1297 and NCYC 2340, NCYC 1297 and NCYC 1296, NCYC 1297 and NCYC 228, NCYC 1297 and NCYC 534, NCYC 1297 and NCYC 2801, NCYC 1297 and NCYC 1366, NCYC 1297 and NCYC 668, NCYC 1297 and NCYC 450, NCYC 1297 and NCYC 1236, NCYC 1297 and NCYC 75, NCYC 1297 and NCYC 112, NCYC 1297 and NCYC 115, NCYC 1297 and NCYC 177, NCYC 1297 and NCYC 223, NCYC 1297 and NCYC 224, NCYC 1297 and NCYC 240, NCYC 1297 and NCYC 340, NCYC 1297 and NCYC 478, NCYC 1297 and NCYC 479, NCYC 1297 and NCYC 510, NCYC 1297 and NCYC 530, NCYC 1297 and NCYC 965, NCYC 1297 and NCYC 969, NCYC 1297 and NCYC 975, NCYC 1297 and NCYC 987, NCYC 1297 and NCYC 989, NCYC 1297 and NCYC 1322, NCYC 1297 and NCYC 1323, NCYC 1297 and NCYC 229, NCYC 1297 and NCYC 230, NCYC 1297 and NCYC 242, NCYC 1297 and NCYC 392, NCYC 1297 and NCYC 397, NCYC 1297 and NCYC 398, NCYC 1297 and NCYC 511, NCYC 1297 and NCYC 584, NCYC 1297 and NCYC 3420, NCYC 1297 and CBS 12357, NCYC 1297 and CBS 7001, NCYC 1297 and CBS 1174, NCYC 1297 and CBS 1177. NCYC 1297 and CBS 1245, NCYC 1297 and CBS 1386, NCYC 1297 and CBS 1488, NCYC 1297 and CBS 1502, NCYC 1297 and CBS 1504, NCYC 1297 and CBS 1548, NCYC 1297 and CBS 1550, NCYC 1297 and CBS 1551, NCYC 1297 and CBS 1552. NCYC 1297 and CBS 1603, NCYC 1297 and CBS 1605, NCYC 1297 and CBS 1606, NCYC 1297 and CBS 1608, NCYC 1297 and CBS 1665, NCYC 1297 and CBS 2165, NCYC 1297 and CBS 2442, NCYC 1297 and CBS 2945, NCYC 1297 and CBS 2954. NCYC 1297 and CBS 2986, NCYC 1297 and CBS 6166, NCYC 1297 and CBS 6017, NCYC 1297 and yHDPN 421, NCYC 1297 and yHKS 210, NCYC 1297 and yHKS 212, NCYC 1297 and yHKS 509, NCYC 1297 and yHRVM 107, NCYC 1297 and NCYC 966, and NCYC 1297 and CBS 1483; NCYC 1073 and NCYC 1262, NCYC 1073 and NCYC 227, NCYC 1073 and NCYC 699, NCYC 1073 and NCYC 487, NCYC 1073 and NCYC 2340, NCYC 1073 and NCYC 1296, NCYC 1073 and NCYC 228, NCYC 1073 and NCYC 534, NCYC 1073 and NCYC 2801, NCYC 1073 and NCYC 1365, NCYC 1073 and NCYC 668, NCYC 1073 and NCYC 450, NCYC 1073 and NCYC 1236, NCYC 1073 and NCYC 75, NCYC 1073 and NCYC 112, NCYC 1073 and NCYC 115, NCYC 1073 and NCYC 177, NCYC 1073 and NCYC 223, NCYC 1073 and NCYC 224, NCYC 1073 and NCYC 240, NCYC 1073 and NCYC 340, NCYC 1073 and NCYC 478, NCYC 1073 and NCYC 479, NCYC 1073 and NCYC 510, NCYC 1073 and NCYC 530, NCYC 1073 and NCYC 965, NCYC 1073 and NCYC 969, NCYC 1073 and NCYC 975, NCYC 1073 and NCYC 987, NCYC 1073 and NCYC 989, NCYC 1078 and NCYC 1322, NCYC 1073 and NCYC 1323, NCYC 1073 and NCYC 229, NCYC 1073 and NCYC 230, NCYC 1073 and NCYC 242, NCYC 1073 and NCYC 392, NCYC 1073 and NCYC 397, NCYC 1073 and NCYC 398, NCYC 1073 and NCYC 511, NCYC 1073 and NCYC 584, NCYC 1073 and NCYC 3420, NCYC 1073 and CBS 12357, NCYC 1073 and CBS 7001, NCYC 1073 and CBS 1174, NCYC 1073 and CBS 1177, NCYC 1073 and CBS 1245, NCYC 1073 and CBS 1386, NCYC 1073 and CBS 1488, NCYC 1073 and CBS 1502, NCYC 1073 and CBS 1504, NCYC 1073 and CBS 1548, NCYC 1073 and CBS 1550, NCYC 1073 and CBS 1551, NCYC 1073 and CBS 1552, NCYC 1073 and CBS 1603, NCYC 1073 and CBS 1605, NCYC 1073 and CBS 1606, NCYC 1073 and CBS 1608, NCYC 1073 and CBS 1665, NCYC 1073 and CBS 2165, NCYC 1073 and CBS 2442, NCYC 1073 and CBS 2945, NCYC 1073 and CBS 2954, NCYC 1073 and CBS 2986, NCYC 1073 and CBS 5156, NCYC 1073 and CBS 6017, NCYC 1073 and yHDPN 421, NCYC 1073 and yHKS 210, NCYC 1073 and yHKS 212, NCYC 1073 and yHKS 509, NCYC 1073 and yHRVM 107, NCYC 1073 and NCYC 966, and NCYC 1073 and CBS 1483; NCYC 231 and NCYC 1262, NCYC 231 and NCYC 227, NCYC 231 and NCYC 699, NCYC 231 and NCYC 487, NCYC 231 and NCYC 2340, NCYC 231 and NCYC 1296, NCYC 231 and NCYC 228, NCYC 231 and NCYC 534, NCYC 231 and NCYC 2801, NCYC 231 and NCYC 1365, NCYC 231 and NCYC 668, NCYC 231 and NCYC 450, NCYC 231 and NCYC 1236, NCYC 231 and NCYC 76, NCYC 231 and NCYC 112, NCYC 231 and NCYC 115, NCYC 231 and NCYC 177, NCYC 231 and NCYC 223, NCYC 231 and NCYC 224, NCYC 231 and NCYC 240, NCYC 231 and NCYC 340, NCYC 231 and NCYC 478, NCYC 231 and NCYC 479, NCYC 231 and NCYC 510, NCYC 231 and NCYC 530, NCYC 231 and NCYC 965, NCYC 231 and NCYC 969, NCYC 231 and NCYC 975, NCYC 231 and NCYC 987, NCYC 231 and NCYC 989, NCYC 231 and NCYC 1322, NCYC 231 and NCYC 1323, NCYC 231 and NCYC 229, NCYC 231 and NCYC 230, NCYC 231 and NCYC 242, NCYC 231 and NCYC 392, NCYC 231 and NCYC 397, NCYC 231 and NCYC 398, NCYC 231 and NCYC 511, NCYC 231 and NCYC 584, NCYC 231 and NCYC 3420, NCYC 231 and CBS 12357, NCYC 231 and CBS 7001, NCYC 231 and CBS 1174, NCYC 231 and CBS 1177, NCYC 231 and CBS 1245, NCYC 231 and CBS 1386, NCYC 231 and CBS 1488, NCYC 231 and CBS 1502, NCYC 231 and CBS 1504. NCYC 231 and CBS 1548, NCYC 231 and CBS 1550, NCYC 231 and CBS 1551, NCYC 231 and CBS 1552, NCYC 231 and CBS 1603, NCYC 231 and CBS 1606, NCYC 231 and CBS 1606, NCYC 231 and CBS 1608, NCYC 231 and CBS 1665. NCYC 231 and CBS 2165, NCYC 231 and CBS 2442, NCYC 231 and CBS 2945, NCYC 231 and CBS 2954, NCYC 231 and CBS 2986, NCYC 231 and CBS 5156, NCYC 231 and CBS 6017, NCYC 231 and yHDPN 421, NCYC 231 and yHKS 210, NCYC 231 and yHKS 212, NCYC 231 and yHKS 509, NCYC 231 and yHRVM 107, NCYC 231 and NCYC 966, and NCYC 231 and CBS 1483; NCYC 1305 and NCYC 1262, NCYC 1305 and NCYC 227, NCYC 1305 and NCYC 699, NCYC 1305 and NCYC 487, NCYC 1305 and NCYC 2340, NCYC 1305 and NCYC 1296, NCYC 1305 and NCYC 228, NCYC 1305 and NCYC 534, NCYC 1305 and NCYC 2801, NCYC 1305 and NCYC 1365, NCYC 1305 and NCYC 668, NCYC 1305 and NCYC 450, NCYC 1305 and NCYC 1236, NCYC 1305 and NCYC 75, NCYC 1305 and NCYC 112, NCYC 1305 and NCYC 115, NCYC 1306 and NCYC 177, NCYC 1305 and NCYC 223, NCYC 1305 and NCYC 224, NCYC 1305 and NCYC 240, NCYC 1305 and NCYC 340, NCYC 1305 and NCYC 478, NCYC 1305 and NCYC 479, NCYC 1305 and NCYC 510, NCYC 1305 and NCYC 530, NCYC 1305 and NCYC 965, NCYC 1305 and NCYC 969, NCYC 1305 and NCYC 975, NCYC 1305 and NCYC 987, NCYC 1305 and NCYC 989, NCYC 1305 and NCYC 1322, NCYC 1305 and NCYC 1323, NCYC 1305 and NCYC 229, NCYC 1305 and NCYC 230, NCYC 1305 and NCYC 242, NCYC 1305 and NCYC 392, NCYC 1305 and NCYC 397, NCYC 1305 and NCYC 398, NCYC 1305 and NCYC 511, NCYC 1305 and NCYC 584, NCYC 1305 and NCYC 3420, NCYC 1305 and CBS 12357, NCYC 1305 and CBS 7001, NCYC 1305 and CBS 1174, NCYC 1305 and CBS 1177, NCYC 1305 and CBS 1245, NCYC 1305 and CBS 1386, NCYC 1305 and CBS 1488, NCYC 1305 and CBS 1502, NCYC 1305 and CBS 1504, NCYC 1305 and CBS 1548, NCYC 1305 and CBS 1550, NCYC 1305 and CBS 1561, NCYC 1305 and CBS 1552, NCYC 1305 and CBS 1603, NCYC 1305 and CBS 1605, NCYC 1305 and CBS 1606, NCYC 1305 and CBS 1608, NCYC 1305 and CBS 1665, NCYC 1305 and CBS 2165, NCYC 1305 and CBS 2442, NCYC 1306 and CBS 2945, NCYC 1305 and CBS 2964, NCYC 1305 and CBS 2986, NCYC 1305 and CBS 5156, NCYC 1305 and CBS 6017, NCYC 1305 and yHDPN 421, NCYC 1305 and yHKS 210, NCYC 1305 and yHKS 212, NCYC 1305 and yHKS 509, NCYC 1305 and yHRVM 107, NCYC 1305 and NCYC 966, and NCYC 1305 and CBS 1483: CBS 6903 and NCYC 1262, CBS 6903 and NCYC 227, CBS 6903 and NCYC 699. CBS 6903 and NCYC 487, CBS 6903 and NCYC 2340, CBS 6903 and NCYC 1296, CBS 6903 and NCYC 228, CBS 6903 and NCYC 534, CBS 6903 and NCYC 2801, CBS 6903 and NCYC 1365, CBS 6903 and NCYC 668, CBS 6903 and NCYC 450. CBS 6903 and NCYC 1236, CBS 6903 and NCYC 75, CBS 6903 and NCYC 112, CBS 6903 and NCYC 115, CBS 6903 and NCYC 177, CBS 6903 and NCYC 223, CBS 6903 and NCYC 224, CBS 6903 and NCYC 240, CBS 6903 and NCYC 340. CBS 6903 and NCYC 478, CBS 6903 and NCYC 479, CBS 6903 and NCYC 510, CBS 6903 and NCYC 530, CBS 6903 and NCYC 965, CBS 6903 and NCYC 969, CBS 6903 and NCYC 975, CBS 6903 and NCYC 987. CBS 6903 and NCYC 989. CBS 6903 and NCYC 1322, CBS 6903 and NCYC 1323, CBS 6903 and NCYC 229, CBS 6903 and NCYC 230, CBS 6903 and NCYC 242, CBS 6903 and NCYC 392, CBS 6903 and NCYC 397, CBS 6903 and NCYC 398, CBS 6903 and NCYC 511. CBS 6903 and NCYC 584, CBS 6903 and NCYC 3420, CBS 6903 and CBS 12357, CBS 6903 and CBS 7001, CBS 6903 and CBS 1174, CBS 6903 and CBS 1177, CBS 6903 and CBS 1245, CBS 6903 and CBS 1386, CBS 6903 and CBS 1488, CBS 6903 and CBS 1502. CBS 6903 and CBS 1504. CBS 6903 and CBS 1548, CBS 6903 and CBS 1550, CBS 6903 and CBS 1551, CBS 6903 and CBS 1552, CBS 6903 and CBS 1603, CBS 6903 and CBS 1605, CBS 6903 and CBS 1606, CBS 6903 and CBS 1608, CBS 6903 and CBS 1665. CBS 6903 and CBS 2165, CBS 6903 and CBS 2442, CBS 6903 and CBS 2945. CBS 6903 and CBS 2954, CBS 6903 and CBS 2986, CBS 6903 and CBS 5156, CBS 6903 and CBS 6017, CBS 6903 and yHDPN 421, CBS 6903 and yHKS 210. CBS 6903 and yHKS 212, CBS 6903 and yHKS 509, CBS 6903 and yHRVM 107, CBS 6903 and NCYC 966, and CBS 6903 and CBS 1483; NCYC 203 and NCYC 1262, NCYC 203 and NCYC 227, NCYC 203 and NCYC 699, NCYC 203 and NCYC 487, NCYC 203 and NCYC 2340, NCYC 203 and NCYC 1296, NCYC 203 and NCYC 228, NCYC 203 and NCYC 534, NCYC 203 and NCYC 2801, NCYC 203 and NCYC 1365, NCYC 203 and NCYC 668, NCYC 203 and NCYC 450, NCYC 203 and NCYC 1236, NCYC 203 and NCYC 75, NCYC 203 and NCYC 112, NCYC 203 and NCYC 115, NCYC 203 and NCYC 177, NCYC 203 and NCYC 223, NCYC 203 and NCYC 224, NCYC 203 and NCYC 240, NCYC 203 and NCYC 340, NCYC 203 and NCYC 478, NCYC 203 and NCYC 479, NCYC 203 and NCYC 610, NCYC 203 and NCYC 530, NCYC 203 and NCYC 966, NCYC 203 and NCYC 969, NCYC 203 and NCYC 975, NCYC 203 and NCYC 987, NCYC 203 and NCYC 989, NCYC 203 and NCYC 1322, NCYC 203 and NCYC 1323, NCYC 203 and NCYC 229, NCYC 203 and NCYC 230, NCYC 203 and NCYC 242, NCYC 203 and NCYC 392, NCYC 203 and NCYC 397, NCYC 203 and NCYC 398, NCYC 203 and NCYC 511, NCYC 203 and NCYC 584, NCYC 203 and NCYC 3420, NCYC 203 and CBS 12357, NCYC 203 and CBS 7001, NCYC 203 and CBS 1174, NCYC 203 and CBS 1177, NCYC 203 and CBS 1245, NCYC 203 and CBS 1386, NCYC 203 and CBS 1488, NCYC 203 and CBS 1502, NCYC 203 and CBS 1504, NCYC 203 and CBS 1548, NCYC 203 and CBS 1550, NCYC 203 and CBS 1551, NCYC 203 and CBS 1552, NCYC 203 and CBS 1603, NCYC 203 and CBS 1605, NCYC 203 and CBS 1606, NCYC 203 and CBS 1608, NCYC 203 and CBS 1666, NCYC 203 and CBS 2165, NCYC 203 and CBS 2442, NCYC 203 and CBS 2945, NCYC 203 and CBS 2954, NCYC 203 and CBS 2986, NCYC 203 and CBS 5156, NCYC 203 and CBS 6017, NCYC 203 and yHDPN 421, NCYC 203 and yHKS 210, NCYC 203 and yHKS 212, NCYC 203 and yHKS 509, NCYC 203 and yHRVM 107, NCYC 203 and NCYC 966, and NCYC 203 and CBS 1483: CBS 2443 and NCYC 1262, CBS 2443 and NCYC 227. CBS 2443 and NCYC 699, CBS 2443 and NCYC 487, CBS 2443 and NCYC 2340, CBS 2443 and NCYC 1296, CBS 2443 and NCYC 228, CBS 2443 and NCYC 534, CBS 2443 and NCYC 2801, CBS 2443 and NCYC 1365, CBS 2443 and NCYC 668. CBS 2443 and NCYC 450, CBS 2443 and NCYC 1236, CBS 2443 and NCYC 75, CBS 2443 and NCYC 112, CBS 2443 and NCYC 115, CBS 2443 and NCYC 177, CBS 2443 and NCYC 223, CBS 2443 and NCYC 224, CBS 2443 and NCYC 240, CBS 2443 and NCYC 340, CBS 2443 and NCYC 478, CBS 2443 and NCYC 479, CBS 2443 and NCYC 510, CBS 2443 and NCYC 530, CBS 2443 and NCYC 965, CBS 2443 and NCYC 969, CBS 2443 and NCYC 975, CBS 2443 and NCYC 987, CBS 2443 and NCYC 989, CBS 2443 and NCYC 1322, CBS 2443 and NCYC 1323, CBS 2443 and NCYC 229, CBS 2443 and NCYC 230, CBS 2443 and NCYC 242, CBS 2443 and NCYC 392, CBS 2443 and NCYC 397, CBS 2443 and NCYC 398, CBS 2443 and NCYC 511, CBS 2443 and NCYC 584, CBS 2443 and NCYC 3420, CBS 2443 and CBS 12357, CBS 2443 and CBS 7001, CBS 2443 and CBS 1174, CBS 2443 and CBS 1177, CBS 2443 and CBS 1245, CBS 2443 and CBS 1386, CBS 2443 and CBS 1488. CBS 2443 and CBS 1602, CBS 2443 and CBS 1504, CBS 2443 and CBS 1548. CBS 2443 and CBS 1650, CBS 2443 and CBS 1551. CBS 2443 and CBS 1552, CBS 2443 and CBS 1603, CBS 2443 and CBS 1605, CBS 2443 and CBS 1606, CBS 2443 and CBS 1608, CBS 2443 and CBS 1665, CBS 2443 and CBS 2165, CBS 2443 and CBS 2442, CBS 2443 and CBS 2945, CBS 2443 and CBS 2954, CBS 2443 and CBS 2986, CBS 2443 and CBS 5156, CBS 2443 and CBS 6017, CBS 2443 and yHDPN 421, CBS 2443 and yHKS 210, CBS 2443 and yHKS 212, CBS 2443 and yHKS 509, CBS 2443 and yHRVM 107, CBS 2443 and NCYC 966, and CBS 2443 and CBS 1483; NCYC 2339 and NCYC 1262, NCYC 2339 and NCYC 227, NCYC 2339 and NCYC 699, NCYC 2339 and NCYC 487, NCYC 2339 and NCYC 2340, NCYC 2339 and NCYC 1296, NCYC 2339 and NCYC 228, NCYC 2339 and NCYC 534, NCYC 2339 and NCYC 2801, NCYC 2339 and NCYC 1366, NCYC 2339 and NCYC 668, NCYC 2339 and NCYC 450, NCYC 2339 and NCYC 1236, NCYC 2339 and NCYC 75, NCYC 2339 and NCYC 112, NCYC 2339 and NCYC 115, NCYC 2339 and NCYC 177, NCYC 2339 and NCYC 223, NCYC 2339 and NCYC 224, NCYC 2339 and NCYC 240, NCYC 2339 and NCYC 340, NCYC 2339 and NCYC 478, NCYC 2339 and NCYC 479, NCYC 2339 and NCYC 510, NCYC 2339 and NCYC 530, NCYC 2339 and NCYC 965, NCYC 2339 and NCYC 969, NCYC 2339 and NCYC 975, NCYC 2339 and NCYC 987, NCYC 2339 and NCYC 989, NCYC 2339 and NCYC 1322, NCYC 2339 and NCYC 1323, NCYC 2339 and NCYC 229, NCYC 2339 and NCYC 230, NCYC 2339 and NCYC 242, NCYC 2339 and NCYC 392, NCYC 2339 and NCYC 397, NCYC 2339 and NCYC 398, NCYC 2339 and NCYC 511, NCYC 2339 and NCYC 584, NCYC 2339 and NCYC 3420, NCYC 2339 and CBS 12357, NCYC 2339 and CBS 7001, NCYC 2339 and CBS 1174, NCYC 2339 and CBS 1177, NCYC 2339 and CBS 1245. NCYC 2339 and CBS 1386, NCYC 2339 and CBS 1488, NCYC 2339 and CBS 1502, NCYC 2339 and CBS 1504, NCYC 2339 and CBS 1548, NCYC 2339 and CBS 1550, NCYC 2339 and CBS 1551, NCYC 2339 and CBS 1552, NCYC 2339 and CBS 1603. NCYC 2339 and CBS 1605, NCYC 2339 and CBS 1606, NCYC 2339 and CBS 1608, NCYC 2339 and CBS 1665, NCYC 2339 and CBS 2165, NCYC 2339 and CBS 2442, NCYC 2339 and CBS 2945, NCYC 2339 and CBS 2954, NCYC 2339 and CBS 2986. NCYC 2339 and CBS 5156, NCYC 2339 and CBS 6017, NCYC 2339 and yHDPN 421, NCYC 2339 and yHKS 210, NCYC 2339 and yHKS 212, NCYC 2339 and yHKS 509, NCYC 2339 and yHRVM 107, NCYC 2339 and NCYC 966, and NCYC 2339 and CBS 1483; NCYC 1324 and NCYC 1262, NCYC 1324 and NCYC 227. NCYC 1324 and NCYC 699, NCYC 1324 and NCYC 487, NCYC 1324 and NCYC 2340, NCYC 1324 and NCYC 1296, NCYC 1324 and NCYC 228, NCYC 1324 and NCYC 534, NCYC 1324 and NCYC 2801, NCYC 1324 and NCYC 1365, NCYC 1324 and NCYC 668, NCYC 1324 and NCYC 450, NCYC 1324 and NCYC 1236, NCYC 1324 and NCYC 75, NCYC 1324 and NCYC 112, NCYC 1324 and NCYC 115. NCYC 1324 and NCYC 177, NCYC 1324 and NCYC 223, NCYC 1324 and NCYC 224, NCYC 1324 and NCYC 240, NCYC 1324 and NCYC 340, NCYC 1324 and NCYC 478, NCYC 1324 and NCYC 479, NCYC 1324 and NCYC 510, NCYC 1324 and NCYC 530, NCYC 1324 and NCYC 965, NCYC 1324 and NCYC 969, NCYC 1324 and NCYC 975, NCYC 1324 and NCYC 987, NCYC 1324 and NCYC 989, NCYC 1324 and NCYC 1322, NCYC 1324 and NCYC 1323, NCYC 1324 and NCYC 229, NCYC 1324 and NCYC 230, NCYC 1324 and NCYC 242, NCYC 1324 and NCYC 392, NCYC 1324 and NCYC 397, NCYC 1324 and NCYC 398, NCYC 1324 and NCYC 511, NCYC 1324 and NCYC 584, NCYC 1324 and NCYC 3420, NCYC 1324 and CBS 12357, NCYC 1324 and CBS 7001, NCYC 1324 and CBS 1174, NCYC 1324 and CBS 1177, NCYC 1324 and CBS 1245, NCYC 1324 and CBS 1386, NCYC 1324 and CBS 1488, NCYC 1324 and CBS 1502, NCYC 1324 and CBS 1504. NCYC 1324 and CBS 1548, NCYC 1324 and CBS 1550, NCYC 1324 and CBS 1551, NCYC 1324 and CBS 1552, NCYC 1324 and CBS 1603, NCYC 1324 and CBS 1605. NCYC 1324 and CBS 1606, NCYC 1324 and CBS 1608, NCYC 1324 and CBS 1665. NCYC 1324 and CBS 2165, NCYC 1324 and CBS 2442, NCYC 1324 and CBS 2945, NCYC 1324 and CBS 2954, NCYC 1324 and CBS 2986, NCYC 1324 and CBS 5156, NCYC 1324 and CBS 6017, NCYC 1324 and yHDPN 421, NCYC 1324 and yHKS 210, NCYC 1324 and yHKS 212, NCYC 1324 and yHKS 509, NCYC 1324 and yHRVM 107, NCYC 1324 and NCYC 966, and NCYC 1324 and CBS 1483; CBS 2898 and NCYC 1262, CBS 2898 and NCYC 227, CBS 2898 and NCYC 699, CBS 2898 and NCYC 487, CBS 2898 and NCYC 2340, CBS 2898 and NCYC 1296, CBS 2898 and NCYC 228, CBS 2898 and NCYC 534. CBS 2898 and NCYC 2801, CBS 2898 and NCYC 1365, CBS 2898 and NCYC 668, CBS 2898 and NCYC 450, CBS 2898 and NCYC 1236, CBS 2898 and NCYC 75, CBS 2898 and NCYC 112, CBS 2898 and NCYC 115, CBS 2898 and NCYC 177. CBS 2898 and NCYC 223, CBS 2898 and NCYC 224, CBS 2898 and NCYC 240, CBS 2898 and NCYC 340, CBS 2898 and NCYC 478, CBS 2898 and NCYC 479, CBS 2898 and NCYC 610, CBS 2898 and NCYC 530, CBS 2898 and NCYC 965, CBS 2898 and NCYC 969, CBS 2898 and NCYC 975, CBS 2898 and NCYC 987, CBS 2898 and NCYC 989. CBS 2898 and NCYC 1322, CBS 2898 and NCYC 1323, CBS 2898 and NCYC 229, CBS 2898 and NCYC 230, CBS 2898 and NCYC 242. CBS 2898 and NCYC 392, CBS 2898 and NCYC 397, CBS 2898 and NCYC 398, CBS 2898 and NCYC 511. CBS 2898 and NCYC 584, CBS 2898 and NCYC 3420. CBS 2898 and CBS 12357, CBS 2898 and CBS 7001, CBS 2898 and CBS 1174, CBS 2898 and CBS 1177, CBS 2898 and CBS 1246, CBS 2898 and CBS 1386, CBS 2898 and CBS 1488. CBS 2898 and CBS 1502, CBS 2898 and CBS 1504, CBS 2898 and CBS 1548, CBS 2898 and CBS 1550, CBS 2898 and CBS 1551, CBS 2898 and CBS 1552, CBS 2898 and CBS 1603, CBS 2898 and CBS 1605, CBS 2898 and CBS 1606. CBS 2898 and CBS 1608, CBS 2898 and CBS 1665, CBS 2898 and CBS 2165, CBS 2898 and CBS 2442, CBS 2898 and CBS 2945. CBS 2898 and CBS 2954, CBS 2898 and CBS 2986, CBS 2898 and CBS 5156, CBS 2898 and CBS 6017, CBS 2898 and yHDPN 421, CBS 2898 and yHKS 210, CBS 2898 and yHKS 212, CBS 2898 and yHKS 509, CBS 2898 and yHRVM 107, CBS 2898 and NCYC 966, and CBS 2898 and CBS 1483; CBS 7240 and NCYC 1262, CBS 7240 and NCYC 227. CBS 7240 and NCYC 699, CBS 7240 and NCYC 487, CBS 7240 and NCYC 2340, CBS 7240 and NCYC 1296, CBS 7240 and NCYC 228, CBS 7240 and NCYC 534, CBS 7240 and NCYC 2801, CBS 7240 and NCYC 1366, CBS 7240 and NCYC 668, CBS 7240 and NCYC 450, CBS 7240 and NCYC 1236. CBS 7240 and NCYC 75, CBS 7240 and NCYC 112, CBS 7240 and NCYC 115, CBS 7240 and NCYC 177, CBS 7240 and NCYC 223, CBS 7240 and NCYC 224, CBS 7240 and NCYC 240. CBS 7240 and NCYC 340, CBS 7240 and NCYC 478, CBS 7240 and NCYC 479, CBS 7240 and NCYC 510, CBS 7240 and NCYC 530, CBS 7240 and NCYC 965, CBS 7240 and NCYC 969, CBS 7240 and NCYC 975, CBS 7240 and NCYC 987. CBS 7240 and NCYC 989, CBS 7240 and NCYC 1322, CBS 7240 and NCYC 1323, CBS 7240 and NCYC 229, CBS 7240 and NCYC 230, CBS 7240 and NCYC 242, CBS 7240 and NCYC 392, CBS 7240 and NCYC 397, CBS 7240 and NCYC 398. CBS 7240 and NCYC 511, CBS 7240 and NCYC 584, CBS 7240 and NCYC 3420, CBS 7240 and CBS 12357, CBS 7240 and CBS 7001, CBS 7240 and CBS 1174, CBS 7240 and CBS 1177, CBS 7240 and CBS 1245, CBS 7240 and CBS 1386, CBS 7240 and CBS 1488, CBS 7240 and CBS 1502, CBS 7240 and CBS 1504, CBS 7240 and CBS 1548, CBS 7240 and CBS 1550. CBS 7240 and CBS 1551, CBS 7240 and CBS 1552, CBS 7240 and CBS 1603, CBS 7240 and CBS 1605, CBS 7240 and CBS 1606, CBS 7240 and CBS 1608, CBS 7240 and CBS 1665, CBS 7240 and CBS 2165, CBS 7240 and CBS 2442, CBS 7240 and CBS 2945, CBS 7240 and CBS 2954, CBS 7240 and CBS 2986, CBS 7240 and CBS 5156, CBS 7240 and CBS 6017, CBS 7240 and yHDPN 421, CBS 7240 and yHKS 210, CBS 7240 and yHKS 212, CBS 7240 and yHKS 509, CBS 7240 and yHRVM 107, CBS 7240 and NCYC 966, and CBS 7240 and CBS 1483; NCYC 1526 and NCYC 1262, NCYC 1626 and NCYC 227, NCYC 1526 and NCYC 699, NCYC 1526 and NCYC 487, NCYC 1526 and NCYC 2340, NCYC 1526 and NCYC 1296, NCYC 1526 and NCYC 228, NCYC 1526 and NCYC 534, NCYC 1526 and NCYC 2801. NCYC 1526 and NCYC 1365, NCYC 1526 and NCYC 668, NCYC 1526 and NCYC 450, NCYC 1526 and NCYC 1236, NCYC 1526 and NCYC 75, NCYC 1526 and NCYC 112, NCYC 1526 and NCYC 115, NCYC 1526 and NCYC 177, NCYC 1526 and NCYC 223, NCYC 1626 and NCYC 224, NCYC 1526 and NCYC 240, NCYC 1526 and NCYC 340, NCYC 1526 and NCYC 478, NCYC 1526 and NCYC 479, NCYC 1526 and NCYC 510, NCYC 1526 and NCYC 530, NCYC 1526 and NCYC 965, NCYC 1526 and NCYC 969, NCYC 1526 and NCYC 975, NCYC 1526 and NCYC 987, NCYC 1526 and NCYC 989, NCYC 1626 and NCYC 1322, NCYC 1526 and NCYC 1323, NCYC 1526 and NCYC 229, NCYC 1526 and NCYC 230, NCYC 1526 and NCYC 242, NCYC 1526 and NCYC 392, NCYC 1526 and NCYC 397, NCYC 1626 and NCYC 398, NCYC 1526 and NCYC 611, NCYC 1526 and NCYC 584, NCYC 1526 and NCYC 3420, NCYC 1526 and CBS 12357, NCYC 1526 and CBS 7001, NCYC 1526 and CBS 1174, NCYC 1526 and CBS 1177, NCYC 1526 and CBS 1245, NCYC 1526 and CBS 1386, NCYC 1526 and CBS 1488, NCYC 1526 and CBS 1502, NCYC 1526 and CBS 1504, NCYC 1526 and CBS 1548, NCYC 1526 and CBS 1550, NCYC 1526 and CBS 1551, NCYC 1526 and CBS 1562, NCYC 1526 and CBS 1603, NCYC 1626 and CBS 1605, NCYC 1526 and CBS 1606, NCYC 1526 and CBS 1608, NCYC 1526 and CBS 1665, NCYC 1526 and CBS 2165, NCYC 1526 and CBS 2442, NCYC 1526 and CBS 2945, NCYC 1526 and CBS 2964, NCYC 1526 and CBS 2986, NCYC 1526 and CBS 5166, NCYC 1526 and CBS 6017, NCYC 1526 and yHDPN 421, NCYC 1526 and yHKS 210, NCYC 1526 and yHKS 212, NCYC 1526 and yHKS 509, NCYC 1526 and yHRVM 107, NCYC 1526 and NCYC 966, and NCYC 1626 and CBS 1483; NCYC 1544 and NCYC 1262, NCYC 1544 and NCYC 227, NCYC 1544 and NCYC 699, NCYC 1544 and NCYC 487, NCYC 1544 and NCYC 2340, NCYC 1544 and NCYC 1296, NCYC 1544 and NCYC 228, NCYC 1544 and NCYC 634, NCYC 1544 and NCYC 2801, NCYC 1544 and NCYC 1365, NCYC 1544 and NCYC 668, NCYC 1544 and NCYC 450, NCYC 1544 and NCYC 1236, NCYC 1544 and NCYC 75, NCYC 1544 and NCYC 112, NCYC 1544 and NCYC 115, NCYC 1544 and NCYC 177, NCYC 1644 and NCYC 223, NCYC 1544 and NCYC 224, NCYC 1544 and NCYC 240, NCYC 1544 and NCYC 340, NCYC 1544 and NCYC 478, NCYC 1644 and NCYC 479, NCYC 1544 and NCYC 510, NCYC 1544 and NCYC 530, NCYC 1544 and NCYC 965, NCYC 1544 and NCYC 969, NCYC 1544 and NCYC 975, NCYC 1544 and NCYC 987, NCYC 1544 and NCYC 989, NCYC 1544 and NCYC 1322, NCYC 1544 and NCYC 1323, NCYC 1544 and NCYC 229, NCYC 1544 and NCYC 230, NCYC 1544 and NCYC 242, NCYC 1544 and NCYC 392, NCYC 1544 and NCYC 397, NCYC 1544 and NCYC 398, NCYC 1544 and NCYC 511, NCYC 1544 and NCYC 584, NCYC 1544 and NCYC 3420, NCYC 1544 and CBS 12357, NCYC 1544 and CBS 7001, NCYC 1544 and CBS 1174, NCYC 1544 and CBS 1177, NCYC 1544 and CBS 1245, NCYC 1544 and CBS 1386, NCYC 1644 and CBS 1488, NCYC 1644 and CBS 1502, NCYC 1544 and CBS 1604, NCYC 1544 and CBS 1548, NCYC 1544 and CBS 1550, NCYC 1544 and CBS 1551, NCYC 1544 and CBS 1552, NCYC 1544 and CBS 1603, NCYC 1544 and CBS 1605, NCYC 1644 and CBS 1606, NCYC 1644 and CBS 1608, NCYC 1544 and CBS 1665, NCYC 1544 and CBS 2165, NCYC 1544 and CBS 2442, NCYC 1544 and CBS 2945, NCYC 1544 and CBS 2954, NCYC 1544 and CBS 2986, NCYC 1544 and CBS 5156, NCYC 1644 and CBS 6017, NCYC 1644 and yHDPN 421, NCYC 1544 and yHKS 210, NCYC 1544 and yHKS 212, NCYC 1544 and yHKS 509, NCYC 1544 and yHRVM 107, NCYC 1544 and NCYC 966, and NCYC 1544 and CBS 1483; NCYC 2359 and NCYC 1262, NCYC 2359 and NCYC 227, NCYC 2369 and NCYC 699, NCYC 2359 and NCYC 487, NCYC 2359 and NCYC 2340, NCYC 2359 and NCYC 1296, NCYC 2359 and NCYC 228, NCYC 2359 and NCYC 534, NCYC 2359 and NCYC 2801, NCYC 2359 and NCYC 1365, NCYC 2359 and NCYC 668, NCYC 2359 and NCYC 450, NCYC 2359 and NCYC 1236, NCYC 2359 and NCYC 75, NCYC 2359 and NCYC 112, NCYC 2359 and NCYC 115, NCYC 2359 and NCYC 177, NCYC 2359 and NCYC 223, NCYC 2359 and NCYC 224, NCYC 2359 and NCYC 240, NCYC 2369 and NCYC 340, NCYC 2359 and NCYC 478, NCYC 2359 and NCYC 479, NCYC 2359 and NCYC 510, NCYC 2359 and NCYC 530, NCYC 2359 and NCYC 965, NCYC 2359 and NCYC 969, NCYC 2359 and NCYC 975, NCYC 2359 and NCYC 987, NCYC 2369 and NCYC 989, NCYC 2359 and NCYC 1322, NCYC 2359 and NCYC 1323, NCYC 2359 and NCYC 229, NCYC 2359 and NCYC 230, NCYC 2359 and NCYC 242, NCYC 2359 and NCYC 392, NCYC 2359 and NCYC 397, NCYC 2359 and NCYC 398, NCYC 2359 and NCYC 511, NCYC 2359 and NCYC 584, NCYC 2359 and NCYC 3420, NCYC 2359 and CBS 12357, NCYC 2359 and CBS 7001, NCYC 2359 and CBS 1174, NCYC 2359 and CBS 1177. NCYC 2359 and CBS 1245, NCYC 2359 and CBS 1386, NCYC 2359 and CBS 1488, NCYC 2359 and CBS 1502, NCYC 2359 and CBS 1504, NCYC 2359 and CBS 1548, NCYC 2359 and CBS 1550, NCYC 2359 and CBS 1551, NCYC 2369 and CBS 1552. NCYC 2359 and CBS 1603, NCYC 2359 and CBS 1605, NCYC 2359 and CBS 1606, NCYC 2359 and CBS 1608, NCYC 2359 and CBS 1665, NCYC 2359 and CBS 2165, NCYC 2359 and CBS 2442, NCYC 2359 and CBS 2945, NCYC 2359 and CBS 2954. NCYC 2359 and CBS 2986, NCYC 2359 and CBS 5156, NCYC 2359 and CBS 6017, NCYC 2359 and yHDPN 421, NCYC 2359 and yHKS 210, NCYC 2359 and yHKS 212, NCYC 2369 and yHKS 509, NCYC 2359 and yHRVM 107, NCYC 2359 and NCYC 966, and NCYC 2369 and CBS 1483; NCYC 986 and NCYC 1262, NCYC 986 and NCYC 227, NCYC 986 and NCYC 699, NCYC 986 and NCYC 487, NCYC 986 and NCYC 2340, NCYC 986 and NCYC 1296, NCYC 986 and NCYC 228, NCYC 986 and NCYC 634, NCYC 986 and NCYC 2801, NCYC 986 and NCYC 1365, NCYC 986 and NCYC 668, NCYC 986 and NCYC 450, NCYC 986 and NCYC 1236, NCYC 986 and NCYC 75, NCYC 986 and NCYC 112, NCYC 986 and NCYC 115. NCYC 986 and NCYC 177, NCYC 986 and NCYC 223, NCYC 986 and NCYC 224, NCYC 986 and NCYC 240, NCYC 986 and NCYC 340, NCYC 986 and NCYC 478, NCYC 986 and NCYC 479, NCYC 986 and NCYC 510, NCYC 986 and NCYC 580, NCYC 986 and NCYC 965, NCYC 986 and NCYC 969, NCYC 986 and NCYC 975, NCYC 986 and NCYC 987, NCYC 986 and NCYC 989, NCYC 986 and NCYC 1322, NCYC 986 and NCYC 1323, NCYC 986 and NCYC 229, NCYC 986 and NCYC 230, NCYC 986 and NCYC 242, NCYC 986 and NCYC 392, NCYC 986 and NCYC 397, NCYC 986 and NCYC 398, NCYC 986 and NCYC 511, NCYC 986 and NCYC 584, NCYC 986 and NCYC 3420, NCYC 986 and CBS 12357, NCYC 986 and CBS 7001, NCYC 986 and CBS 1174, NCYC 986 and CBS 1177, NCYC 986 and CBS 1245. NCYC 986 and CBS 1386, NCYC 986 and CBS 1488, NCYC 986 and CBS 1502, NCYC 986 and CBS 1504, NCYC 986 and CBS 1548, NCYC 986 and CBS 1550, NCYC 986 and CBS 1551, NCYC 986 and CBS 1562, NCYC 986 and CBS 1603. NCYC 986 and CBS 1605, NCYC 986 and CBS 1606, NCYC 986 and CBS 1608, NCYC 986 and CBS 1665, NCYC 986 and CBS 2165, NCYC 986 and CBS 2442, NCYC 986 and CBS 2946, NCYC 986 and CBS 2954, NCYC 986 and CBS 2986. NCYC 986 and CBS 5156, NCYC 986 and CBS 6017, NCYC 986 and yHDPN 421, NCYC 986 and yHKS 210, NCYC 986 and yHKS 212, NCYC 986 and yHKS 509. NCYC 986 and yHRVM 107, NCYC 986 and NCYC 966, and NCYC 986 and CBS 1483; NCYC 1295 and NCYC 1262, NCYC 1295 and NCYC 227, NCYC 1295 and NCYC 699, NCYC 1295 and NCYC 487, NCYC 1295 and NCYC 2340, NCYC 1295 and NCYC 1296, NCYC 1295 and NCYC 228, NCYC 1295 and NCYC 534, NCYC 1295 and NCYC 2801, NCYC 1295 and NCYC 1365, NCYC 1295 and NCYC 668, NCYC 1295 and NCYC 450, NCYC 1295 and NCYC 1236, NCYC 1295 and NCYC 75, NCYC 1295 and NCYC 112, NCYC 1295 and NCYC 115, NCYC 1295 and NCYC 177, NCYC 1295 and NCYC 223, NCYC 1295 and NCYC 224, NCYC 1295 and NCYC 240, NCYC 1295 and NCYC 340, NCYC 1295 and NCYC 478, NCYC 1295 and NCYC 479, NCYC 1295 and NCYC 610, NCYC 1295 and NCYC 530, NCYC 1295 and NCYC 965, NCYC 1295 and NCYC 969, NCYC 1295 and NCYC 975, NCYC 1295 and NCYC 987, NCYC 1295 and NCYC 989, NCYC 1295 and NCYC 1322, NCYC 1295 and NCYC 1323, NCYC 1295 and NCYC 229, NCYC 1295 and NCYC 230, NCYC 1295 and NCYC 242, NCYC 1295 and NCYC 392, NCYC 1295 and NCYC 397, NCYC 1295 and NCYC 398, NCYC 1295 and NCYC 511, NCYC 1296 and NCYC 584, NCYC 1295 and NCYC 3420, NCYC 1295 and CBS 12357, NCYC 1295 and CBS 7001, NCYC 1295 and CBS 1174, NCYC 1295 and CBS 1177, NCYC 1295 and CBS 1245, NCYC 1295 and CBS 1386, NCYC 1295 and CBS 1488, NCYC 1295 and CBS 1502, NCYC 1295 and CBS 1504, NCYC 1296 and CBS 1548, NCYC 1295 and CBS 1550, NCYC 1295 and CBS 1551, NCYC 1295 and CBS 1552, NCYC 1295 and CBS 1603, NCYC 1295 and CBS 1605, NCYC 1295 and CBS 1606, NCYC 1295 and CBS 1608, NCYC 1295 and CBS 1666, NCYC 1296 and CBS 2165, NCYC 1295 and CBS 2442, NCYC 1295 and CBS 2945, NCYC 1295 and CBS 2954, NCYC 1295 and CBS 2986, NCYC 1295 and CBS 6166, NCYC 1295 and CBS 6017, NCYC 1295 and yHDPN 421, NCYC 1295 and yHKS 210, NCYC 1295 and yHKS 212, NCYC 1295 and yHKS 509, NCYC 1295 and yHRVM 107, NCYC 1295 and NCYC 966, and NCYC 1295 and CBS 1483; NCYC 1516 and NCYC 1262, NCYC 1516 and NCYC 227, NCYC 1516 and NCYC 699, NCYC 1516 and NCYC 487, NCYC 1516 and NCYC 2340, NCYC 1516 and NCYC 1296, NCYC 1516 and NCYC 228, NCYC 1516 and NCYC 534, NCYC 1516 and NCYC 2801, NCYC 1516 and NCYC 1365, NCYC 1616 and NCYC 668, NCYC 1516 and NCYC 450, NCYC 1516 and NCYC 1236, NCYC 1516 and NCYC 75, NCYC 1516 and NCYC 112, NCYC 1516 and NCYC 115, NCYC 1516 and NCYC 177, NCYC 1516 and NCYC 223, NCYC 1516 and NCYC 224, NCYC 1516 and NCYC 240, NCYC 1516 and NCYC 340, NCYC 1516 and NCYC 478, NCYC 1516 and NCYC 479, NCYC 1516 and NCYC 510, NCYC 1616 and NCYC 530, NCYC 1516 and NCYC 965, NCYC 1516 and NCYC 969, NCYC 1516 and NCYC 975, NCYC 1516 and NCYC 987, NCYC 1516 and NCYC 989, NCYC 1516 and NCYC 1322, NCYC 1516 and NCYC 1323, NCYC 1516 and NCYC 229, NCYC 1516 and NCYC 230, NCYC 1516 and NCYC 242, NCYC 1516 and NCYC 392, NCYC 1516 and NCYC 397, NCYC 1516 and NCYC 398, NCYC 1516 and NCYC 511, NCYC 1516 and NCYC 584, NCYC 1516 and NCYC 3420, NCYC 1516 and CBS 12357, NCYC 1516 and CBS 7001, NCYC 1516 and CBS 1174, NCYC 1516 and CBS 1177, NCYC 1516 and CBS 1245, NCYC 1516 and CBS 1386, NCYC 1516 and CBS 1488, NCYC 1516 and CBS 1502. NCYC 1516 and CBS 1504, NCYC 1516 and CBS 1548, NCYC 1516 and CBS 1550. NCYC 1516 and CBS 1561, NCYC 1516 and CBS 1562, NCYC 1516 and CBS 1603, NCYC 1516 and CBS 1605, NCYC 1516 and CBS 1606, NCYC 1516 and CBS 1608. NCYC 1516 and CBS 1665, NCYC 1616 and CBS 2165, NCYC 1516 and CBS 2442. NCYC 1616 and CBS 2945, NCYC 1516 and CBS 2964, NCYC 1516 and CBS 2986, NCYC 1516 and CBS 5156, NCYC 1516 and CBS 6017, NCYC 1516 and yHDPN 421, NCYC 1516 and yHKS 210, NCYC 1516 and yHKS 212, NCYC 1516 and yHKS 509, NCYC 1516 and yHRVM 107, NCYC 1516 and NCYC 966, and NCYC 1516 and CBS 1483; NCYC 1326 and NCYC 1262, NCYC 1326 and NCYC 227, NCYC 1326 and NCYC 699, NCYC 1326 and NCYC 487, NCYC 1326 and NCYC 2340, NCYC 1326 and NCYC 1296, NCYC 1326 and NCYC 228, NCYC 1326 and NCYC 534, NCYC 1326 and NCYC 2801, NCYC 1326 and NCYC 1365, NCYC 1326 and NCYC 668, NCYC 1326 and NCYC 450, NCYC 1326 and NCYC 1236, NCYC 1326 and NCYC 75, NCYC 1326 and NCYC 112, NCYC 1326 and NCYC 115, NCYC 1326 and NCYC 177, NCYC 1326 and NCYC 223, NCYC 1326 and NCYC 224, NCYC 1326 and NCYC 240, NCYC 1326 and NCYC 340, NCYC 1326 and NCYC 478, NCYC 1326 and NCYC 479, NCYC 1326 and NCYC 610, NCYC 1326 and NCYC 530, NCYC 1326 and NCYC 965, NCYC 1326 and NCYC 969, NCYC 1326 and NCYC 975, NCYC 1326 and NCYC 987, NCYC 1326 and NCYC 989, NCYC 1326 and NCYC 1322, NCYC 1326 and NCYC 1323, NCYC 1326 and NCYC 229, NCYC 1326 and NCYC 230, NCYC 1326 and NCYC 242, NCYC 1326 and NCYC 392, NCYC 1326 and NCYC 397, NCYC 1326 and NCYC 398, NCYC 1326 and NCYC 511, NCYC 1326 and NCYC 584, NCYC 1326 and NCYC 3420, NCYC 1326 and CBS 12357, NCYC 1326 and CBS 7001, NCYC 1326 and CBS 1174, NCYC 1326 and CBS 1177, NCYC 1326 and CBS 1245, NCYC 1326 and CBS 1386. NCYC 1326 and CBS 1488, NCYC 1326 and CBS 1502, NCYC 1326 and CBS 1504, NCYC 1326 and CBS 1548, NCYC 1326 and CBS 1550, NCYC 1326 and CBS 1551, NCYC 1326 and CBS 1552, NCYC 1326 and CBS 1603, NCYC 1326 and CBS 1605. NCYC 1326 and CBS 1606, NCYC 1326 and CBS 1608, NCYC 1326 and CBS 1665, NCYC 1326 and CBS 2165, NCYC 1326 and CBS 2442, NCYC 1326 and CBS 2945, NCYC 1326 and CBS 2954, NCYC 1326 and CBS 2986, NCYC 1326 and CBS 5156. NCYC 1326 and CBS 6017, NCYC 1326 and yHDPN 421, NCYC 1326 and yHKS 210, NCYC 1326 and yHKS 212, NCYC 1326 and yHKS 509, NCYC 1326 and yHRVM 107, NCYC 1826 and NCYC 966, and NCYC 1326 and CBS 1483; NCYC 2398 and NCYC 1262, NCYC 2398 and NCYC 227, NCYC 2398 and NCYC 699, NCYC 2398 and NCYC 487, NCYC 2398 and NCYC 2340, NCYC 2398 and NCYC 1296, NCYC 2398 and NCYC 228, NCYC 2398 and NCYC 534, NCYC 2398 and NCYC 2801, NCYC 2398 and NCYC 1365, NCYC 2398 and NCYC 668, NCYC 2398 and NCYC 450, NCYC 2398 and NCYC 1236, NCYC 2398 and NCYC 75, NCYC 2398 and NCYC 112, NCYC 2398 and NCYC 115, NCYC 2398 and NCYC 177, NCYC 2398 and NCYC 223, NCYC 2398 and NCYC 224, NCYC 2398 and NCYC 240, NCYC 2398 and NCYC 340, NCYC 2398 and NCYC 478, NCYC 2398 and NCYC 479, NCYC 2398 and NCYC 510, NCYC 2398 and NCYC 530, NCYC 2398 and NCYC 965, NCYC 2398 and NCYC 969, NCYC 2398 and NCYC 975, NCYC 2398 and NCYC 987, NCYC 2398 and NCYC 989, NCYC 2398 and NCYC 1322, NCYC 2398 and NCYC 1323, NCYC 2398 and NCYC 229, NCYC 2398 and NCYC 230, NCYC 2398 and NCYC 242, NCYC 2398 and NCYC 392, NCYC 2398 and NCYC 397, NCYC 2398 and NCYC 398, NCYC 2398 and NCYC 511, NCYC 2398 and NCYC 584, NCYC 2398 and NCYC 3420, NCYC 2398 and CBS 12357, NCYC 2398 and CBS 7001, NCYC 2398 and CBS 1174, NCYC 2398 and CBS 1177, NCYC 2398 and CBS 1245, NCYC 2398 and CBS 1386, NCYC 2398 and CBS 1488, NCYC 2398 and CBS 1502, NCYC 2398 and CBS 1504, NCYC 2398 and CBS 1548, NCYC 2398 and CBS 1560, NCYC 2398 and CBS 1551, NCYC 2398 and CBS 1552, NCYC 2398 and CBS 1603, NCYC 2398 and CBS 1605, NCYC 2398 and CBS 1606, NCYC 2398 and CBS 1608, NCYC 2398 and CBS 1665, NCYC 2398 and CBS 2165, NCYC 2398 and CBS 2442, NCYC 2398 and CBS 2945, NCYC 2398 and CBS 2954, NCYC 2398 and CBS 2986, NCYC 2398 and CBS 5156, NCYC 2398 and CBS 6017, NCYC 2398 and yHDPN 421, NCYC 2398 and yHKS 210, NCYC 2398 and yHKS 212, NCYC 2398 and yHKS 509, NCYC 2398 and yHRVM 107, NCYC 2398 and NCYC 966, and NCYC 2398 and CBS 1483; NCYC 669 and NCYC 1262, NCYC 669 and NCYC 227, NCYC 669 and NCYC 699, NCYC 669 and NCYC 487, NCYC 669 and NCYC 2340, NCYC 669 and NCYC 1296, NCYC 669 and NCYC 228, NCYC 669 and NCYC 534, NCYC 669 and NCYC 2801, NCYC 669 and NCYC 1365, NCYC 669 and NCYC 668, NCYC 669 and NCYC 450, NCYC 669 and NCYC 1236, NCYC 669 and NCYC 75, NCYC 669 and NCYC 112, NCYC 669 and NCYC 115, NCYC 669 and NCYC 177, NCYC 669 and NCYC 223, NCYC 669 and NCYC 224, NCYC 669 and NCYC 240, NCYC 669 and NCYC 340, NCYC 669 and NCYC 478, NCYC 669 and NCYC 479, NCYC 669 and NCYC 510, NCYC 669 and NCYC 530, NCYC 669 and NCYC 965, NCYC 669 and NCYC 969, NCYC 669 and NCYC 975, NCYC 669 and NCYC 987, NCYC 669 and NCYC 989, NCYC 669 and NCYC 1322, NCYC 669 and NCYC 1323, NCYC 669 and NCYC 229, NCYC 669 and NCYC 230, NCYC 669 and NCYC 242, NCYC 669 and NCYC 392, NCYC 669 and NCYC 397, NCYC 669 and NCYC 398, NCYC 669 and NCYC 511, NCYC 669 and NCYC 584, NCYC 669 and NCYC 3420, NCYC 669 and CBS 12357, NCYC 669 and CBS 7001, NCYC 669 and CBS 1174, NCYC 669 and CBS 1177, NCYC 669 and CBS 1245, NCYC 669 and CBS 1386, NCYC 669 and CBS 1488, NCYC 669 and CBS 1502, NCYC 669 and CBS 1504, NCYC 669 and CBS 1548, NCYC 669 and CBS 1550, NCYC 669 and CBS 1551, NCYC 669 and CBS 1552, NCYC 669 and CBS 1603, NCYC 669 and CBS 1605, NCYC 669 and CBS 1606, NCYC 669 and CBS 1608, NCYC 669 and CBS 1666, NCYC 669 and CBS 2165, NCYC 669 and CBS 2442, NCYC 669 and CBS 2945, NCYC 669 and CBS 2954, NCYC 669 and CBS 2986, NCYC 669 and CBS 5156, NCYC 669 and CBS 6017, NCYC 669 and yHDPN 421, NCYC 669 and yHKS 210, NCYC 669 and yHKS 212, NCYC 669 and yHKS 509, NCYC 669 and yHRVM 107, NCYC 669 and NCYC 966, and NCYC 669 and CBS 1483; NCYC 2921 and NCYC 1262, NCYC 2921 and NCYC 227, NCYC 2921 and NCYC 699, NCYC 2921 and NCYC 487, NCYC 2921 and NCYC 2340, NCYC 2921 and NCYC 1296, NCYC 2921 and NCYC 228, NCYC 2921 and NCYC 534, NCYC 2921 and NCYC 2801, NCYC 2921 and NCYC 1365, NCYC 2921 and NCYC 668, NCYC 2921 and NCYC 450, NCYC 2921 and NCYC 1236, NCYC 2921 and NCYC 75, NCYC 2921 and NCYC 112, NCYC 2921 and NCYC 115, NCYC 2921 and NCYC 177, NCYC 2921 and NCYC 223, NCYC 2921 and NCYC 224, NCYC 2921 and NCYC 240, NCYC 2921 and NCYC 340, NCYC 2921 and NCYC 478, NCYC 2921 and NCYC 479, NCYC 2921 and NCYC 510, NCYC 2921 and NCYC 530, NCYC 2921 and NCYC 965, NCYC 2921 and NCYC 969, NCYC 2921 and NCYC 975, NCYC 2921 and NCYC 987, NCYC 2921 and NCYC 989, NCYC 2921 and NCYC 1322, NCYC 2921 and NCYC 1323, NCYC 2921 and NCYC 229, NCYC 2921 and NCYC 230, NCYC 2921 and NCYC 242, NCYC 2921 and NCYC 392, NCYC 2921 and NCYC 397, NCYC 2921 and NCYC 398, NCYC 2921 and NCYC 511, NCYC 2921 and NCYC 584, NCYC 2921 and NCYC 3420, NCYC 2921 and CBS 12357, NCYC 2921 and CBS 7001, NCYC 2921 and CBS 1174, NCYC 2921 and CBS 1177. NCYC 2921 and CBS 1245, NCYC 2921 and CBS 1386, NCYC 2921 and CBS 1488, NCYC 2921 and CBS 1502, NCYC 2921 and CBS 1504, NCYC 2921 and CBS 1548. NCYC 2921 and CBS 1550, NCYC 2921 and CBS 1551, NCYC 2921 and CBS 1552. NCYC 2921 and CBS 1603, NCYC 2921 and CBS 1605, NCYC 2921 and CBS 1606, NCYC 2921 and CBS 1608, NCYC 2921 and CBS 1665, NCYC 2921 and CBS 2165, NCYC 2921 and CBS 2442, NCYC 2921 and CBS 2945, NCYC 2921 and CBS 2954, NCYC 2921 and CBS 2986, NCYC 2921 and CBS 6156, NCYC 2921 and CBS 6017, NCYC 2921 and yHDPN 421, NCYC 2921 and yHKS 210, NCYC 2921 and yHKS 212, NCYC 2921 and yHKS 509, NCYC 2921 and yHRVM 107, NCYC 2921 and NCYC 966, and NCYC 2921 and CBS 1483.

In an embodiment, said combination of yeasts does not include distiller's yeast, baker's yeast, or distiller's yeast and baker's yeast.

Said yeast may further comprise one or more naturally occurring mutations, and/or mutations resulting from mutagenesis, in at least one of the genes PAD1 and FDC1, a gene involved in transcriptional control of at least one of said genes, and/or a gene encoding a protein involved in uptake of a phenolic acid, preferably ferulic acid, or involved in export of a decarboxylated phenolic compound, preferably 4-vinyl guaiacol, and/or a gene involved in transcriptional control of said gene.

Said combination of yeast strains that have different specificities for fermenting maltose, maltotriose, fructose and/or glucose that are present in wort into ethanol may be added at the same time point to the wort at the start of fermentation, or may be added at different time points one after the other to the wort.

In case large amounts of wort are to be fermented, the yeast strains may be pre-cultured to obtain sufficient amounts of each of the yeast strains that can be added to the wort, either together or a different time points. Preculturing individual strains preferably is performed on specific, defined media or on undefined media such as wort. This preculturing can be done individually, using separated strains, or as a combination. Care has to be taken during preculturing of a combination of yeast strains that have different specificities for fermenting maltose, maltotriose, fructose and/or glucose that the ratio at which the at least two yeast strains with different specificities for fermenting maltose, maltotriose, fructose and/or glucose are present, does not alter during preculturing. This may be clone, for example, by employing culturing media with different ratio's of sugars selected from maltose, maltotriose, fructose and/or glucose. In case one of the at least two yeast strains with different specificities for fermenting maltose, maltotriose, fructose and/or glucose may become dominant, the combination may be grown on a medium comprising more of the sugar or sugars that is/are preferred by the non-dominant strain or strains.

A yeast strain that is a specialist for one of maltose, maltotriose, fructose or glucose is preferably grown on defined media comprising that specific sugar for which the yeast strain has preference.

Said preculturing may be performed in multiple steps. For example, a dried or frozen stock from at least two yeast strains that have different specificities for fermenting maltose, maltotriose, fructose and/or glucose may each be inoculated in a medium or on a plate that comprises said specific sugar to generate a “working” master stock. Said master stock may be grown in a progression of cultures of increasing size until enough yeast is produced to transfer to the propagation plant. The number of transfer steps depends on the amount of yeast strains that is required for inoculation of the wort in the propagation plant, but in general is kept at a minimum to reduce a risk of infection.

Said pre-culturing may include counterselection steps, during which each batch of the specialist yeast strains is inoculated on a medium comprising a combination of the two remaining sugars. Said batch may be discarded if a specialist yeast strain shows enhanced growth on the counterselection medium comprising the other two sugars.

Inoculation of the wort in the propagation plant by the at least two yeast strains that have different specificities for fermenting maltose, maltotriose, fructose and/or glucose may be performed simultaneous or separated in time. Inoculation may be performed in a ratio from 20:1 to 1:20 for each of the at least two yeast strains that have different specificities for fermenting maltose, maltotriose, fructose and/or glucose.

In a preferred embodiment, the wort in the propagation plant is inoculated by two yeast strains that have different specificities for fermenting maltose, maltotriose, fructose and/or glucose that are in a number-based ratio of 20:1, 10:1, 8:1, 5:1, 4:1, 3:1, 2:1, or 1:1.

Said inoculation of the wort in the propagation plant by two yeast strains that have different specificities for fermenting maltose, maltotriose, fructose and/or glucose in a number-based ratio of 20:1, 10:1, 8:1, 5:1, 4:1, 3:1, 2:1, or 1:1, may occur at the start of fermentation, or a different time points during fermentation. For example, fermentation may be started with a yeast strain with preference towards maltotriose at timepoint zero, followed by addition of a yeast strain with preference towards maltose after a certain amount of time, for example after 1 day, two days, three days or five days. Starting fermentation with only one of the yeast strains that has preference for fermenting maltose, maltotriose, fructose or glucose may have the advantage that this strain may not be overgrown by the other strain or strains. However, and as will be recognized by a person skilled in the art, inoculation of the yeast strains that have different specificities for fermenting maltose, maltotriose, fructose and/or glucose at different time points may be equivalent to inoculation of the yeast strains that have different specificities for fermenting maltose, maltotriose, fructose and/or glucose together at the start of fermentation, albeit in a ratio wherein the one yeast strain that would have been used for inoculation at day 0 is in excess over the one or more other yeast strains.

### 5. EXAMPLES

### Example 1

### Materials and Methods

### Stocking of the 143 Yeasts Collection

Lyophilized cells in glass tubes from strains (see Table 1) that were obtained from public yeast collections, were resuspended in sterile water before plating 100 μl of cell resuspension on YPD agar plates (10 g L⁻¹, Bacto yeast extract, 20 g L⁻¹ Bacto peptone, 20 g L⁻¹ glucose and 20 g L⁻¹ agar). After incubation of the plates for 5 days at 20° C., one single colony per strain was picked and inoculated in a 500 ml round bottom flask filled with 35 ml YPD medium (10 g L⁻¹, Bacto yeast extract, 20 g L⁻¹ Bacto peptone, 20 g L⁻¹ glucose). For all other strains, agar slants with individual colonies or pure glycerol stock cultures were directly inoculated in a 500 ml round bottom flask filled with 35 ml YPD. Cultures were incubated in an IInnova 44 incubator shaker (Eppendorf, Nijmegen, The Netherlands) set at 20° C. and 200 rpm, for 48 h. Finally, cultures were supplemented with 30% v/v glycerol and stored at −80° C.

### Wort Media Preparation

16.5 Plato wort, corresponding to about 120 g/L of fermentable sugars, was supplemented with 1.5 mg/L of ZnSO₄. Then, the supplemented wort was autoclaved for 20 min at 110° C. This process resulted in the formation of precipitated flocks, likely due to protein aggregation. Sterile wort was stored at 4° C. before it was filtered using 0.2 μm Nalgene Rapid-Flow bottle-top filters (Thermo Fisher Scientific, Waltham, Massachusetts, United States) and diluted 3 times by addition of sterile demineralized water, resulting in wort medium with a final fermentable sugar concentration of about 40 g/L. Prior to the experiment, wort medium was supplemented with 1.2 ml/L of 20% Pluronic PE9200 antifoam (BASF, Ludwigshafen, Germany).

### Microaerobic Cultivation

Microaerobic cultivation was performed as previously described (Brouwers et al., 2019. bioRxiv 679563; Brouwers et al., 2019. PLoS Genet 15: e1007853). All strains were tested in triplicate. The control strain CBS1483 was taken along in all experiments. One glycerol stock tube (about 1 ml) for each strain was inoculated in a 50 ml CELLSTAR cell culture tube (Greiner Bio-One, Kremsmünster, Austria) filled with 20 ml wort medium. These pre-cultures were incubated at a 45° angle, inside a shaker incubator set at 12° C., 200 rpm for 3 days, or until OD₆₆₀>8. Optical density at 660 nm was monitored using a 7200 Jenway Spectrometer (Jenway, Stone, UK). Each pre-culture was used to inoculate three 250 mL sterile glass bottles filled with 200 ml wort medium and fit with a rubber septum lid to a starting OD₆₆₀ of 0.2. A needle filled with sterile cotton was inserted in the septum of each flask to allow the release of CO2 pressure that may build up during cultivation. Overall, these conditions ensure that a micro-aerobic environment is maintained throughout the experiment. Glass sterile bottles were incubated at 12° C., 200 rpm for about 5 days. Two samples per day were taken by punching a needle through the septum and by aspirating 2 to 5 ml with a sterile syringe. For each sample the OD₆₆₀ was determined, and each sample, after filtration, was analysed by high-pressure liquid chromatography (HPLC) on an Agilent 1260 HPLC (Agilent Technologies, Santa Clara, CA) fitted with a Bio-Rad HPX 87 H column (Bio-Rad, Hercules, CA). The column was eluted at 60° C. with 0.5 g 1-1 H₂SO₄ at a flow rate of 0.6 ml min-1. Metabolite detection was achieved using an Agilent refractive-index detector and an Agilent 1260 VWD detector.

### Results

### Analysis of Ratio of Maltose and Maltotriose Consumption Rates

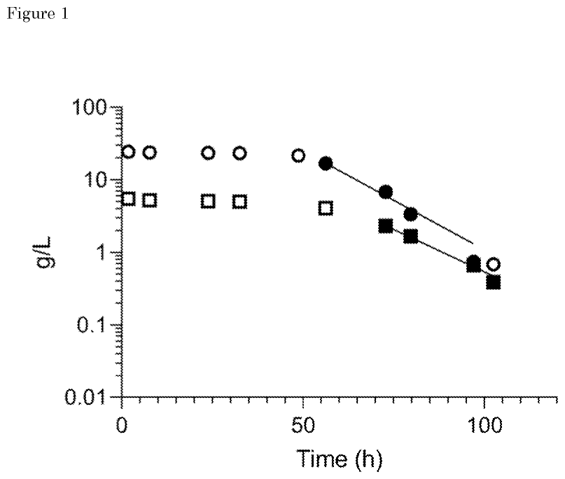

Maltose and maltotriose consumption rates were determined by fitting an exponential curve of formula Y=Y₀*e (k*\), wherein k is the rate constant, to the points in the exponential phase of the consumption curve (see FIG. 1). The value of the slope for maltose was divided by the value of the slope for maltotriose, resulting in a dimension-less value Maltose/Maltotriose (M2/M3) rates ratio. Ratios were maximized to a value of 10. The distribution of M2/M3 rates ratio across all tested strains is shown in FIG. 2. M2/M3 rates ratio values ranged from 0.28 to 10 across all samples. The control strain CBS1483 M2/M3 rates ratio ranged from 4 to 10. Strain CBS1513 (alias NCYC396) had M2/M3 rates ratio ranging from 0.28 to 0.40. Finally, strain WS34/70 had M2/M3 rates ratio ranging from 1.82 to 1.96.

### Example 2. Fermentation of Consortium Composed of the Two Specialists (CBS 1483 and CBS 1513)

### Materials and Methods

### Strains

Yeast strains used in this study are listed in Table 2. Stock cultures were grown at 20° C. in YPD (10 g L⁻¹ Bacto Yeast extract, 20 g L⁻¹ Bacto peptone and 20 g L⁻¹ glucose) until early stationary phase, supplemented with sterile glycerol [final concentration 30% (v/v)] and stored at −80° C. as 1 mL aliquots until further use.

TABLE 2
Yeast strains used in this study.

| Name | Species | Reference |
|---|---|---|
| CBS1483 | Saccharomyces | van den Broek et al., 2015. Appl |
| | pastorianus | Environ Microbiol 81: 6253-6267 |
| WS34/70 | Saccharomyces | Nakao et al., 2009. DNA Res 16: |
| | pastorianus | 115-129. |
| CBS1513 | Saccharomyces | van den Broek et al., 2015. Appl |
| | pastorianus | Environ Microbiol 81: 6253-6267 |

### Media Preparation

Very high gravity (VHG) wort was prepared at the desired apparent extract (AE) by the addition to an industrial wort from barley malt prepared by an infusion mash process including beta amylase and alpha amylase rests, for the production of lager beer (obtained from HEINEKEN Supply Chain B.V., Zoeterwoude, The Netherlands) of 6.6 mg of ZnSO4·7H₂O per liter and 11.63 g of D-maltose monohydrate (Glentham Life Sciences Ltd, Wiltshire, UK) and 3.80 g of a commercial sugar mixture (Dried Glucose syrup C plus 01987, Cargill, Haubourdin, France) per additional degree Plato (° P), per liter. VHG wort was autoclaved at 110° C. for 20 min.

### Tall Tube Characterization

Characterization of the yeast strains and the different culture combinations was performed in 3 L stainless steel (E.B.C. Analytica Microbiologica (1977) Journal of the Institute of Brewing 83:109-118) tall tubes with a working volume of 2.25 L and equipped with a water cooling jacket (Leemberg, Zwijndrecht, The Netherlands). Strains were characterized using both 20° P and 23° P VHG wort. Temperature was controlled at 12° C. by means of a Lauda ECO RE 415 G cryostat (Lauda Dr. R. Wobser GmbH & Co., Lauda-Königshofen, Germany). Pre-cultures were inoculated in 100 mL YPD from frozen stock cultures and grown for ca. 3 days at 12° C. and 200 rpm in an orbital incubator. Cultures from these shake flasks were used to inoculate flasks containing 100 mL YPM 6% (10 g L⁻¹ Bacto Yeast extract, 20 g L⁻¹ Bacto Peptone and 60 g L⁻¹ maltose) to an optical density of 0.8 and grown for ca. 2 days at 12° C. and 200 rpm. Cells from these pre-cultures were harvested by centrifugation (4000 rpm, 10 min., 4° C.), resuspended in demineralized water and used to inoculate VHG wort at a cell concentration of 5·10⁶ cells mL-1. For mixed culture characterizations, the different strains were grown in separate pre-cultures and mixed at the desired ratio before inoculation. Inoculated VHG wort was stirred for 30 min. before transferring it into duplicate tall tubes.

TABLE 1
List of tested strains. Saccharomyces pastorianus, S. cerevisiae, S. bayanus, and S. eubayanus
strains were obtained from public sources such as the National Collection of Yeast Cultures (Norwich, England),
the Westerdijk Fungal Biodiversity Institute (Utrecht, the Netherlands), the Technical University of Munich
(Munich, Germany), and the yH Strain Collection (University of Wisconsin-Madison, USA).

| Strain # | STRAIN NAME | Type | M2rate/M3rate |
|---|---|---|---|
| 1 | NCYC 73 | Generalist | 2.1 |
| 2 | NCYC 75 | Maltose Specialist | 10 |
| 3 | NCYC 112 | Maltose Specialist | 10 |
| 4 | NCYC 115 | Maltose Specialist | 10 |
| 5 | NCYC 177 | Maltose Specialist | 10 |
| 6 | NCYC 223 | Maltose Specialist | 10 |
| 7 | NCYC 224 | Maltose Specialist | 10 |
| 8 | NCYC 240 | Maltose Specialist | 10 |
| 9 | NCYC 340 | Maltose Specialist | 10 |
| 10 | NCYC 396 | Maltotriose Specialist | 0.3 |
| 11 | NCYC 456 | Generalist | 2.2 |
| 12 | NCYC 457 | Maltotriose Specialist | 0.4 |
| 13 | NCYC 478 | Maltose Specialist | 10 |
| 14 | NCYC 479 | Maltose Specialist | 10 |
| 15 | NCYC 487 | Maltose Specialist | 4.7 |
| 16 | NCYC 510 | Maltose Specialist | 10 |
| 17 | NCYC 529 | Generalist | 1.6 |
| 18 | NCYC 530 | Maltose Specialist | 10 |
| 19 | NCYC 531 | Generalist | 1.8 |
| 20 | NCYC 534 | Maltose Specialist | 5.7 |
| 21 | NCYC 668 | Maltose Specialist | 7.6 |
| 22 | NCYC 669 | Maltotriose Specialist | 1.58 |
| 23 | NCYC 670 | Generalist | 2.1 |
| 24 | NCYC 699 | Maltose Specialist | 4.3 |
| 25 | NCYC 965 | Maltose Specialist | 10 |
| 26 | NCYC 966 | Maltose Specialist | 5.2 |
| 27 | NCYC 967 | Generalist | 3.9 |
| 28 | NCYC 969 | Maltose Specialist | 10 |
| 29 | NCYC 975 | Maltose Specialist | 10 |
| 30 | NCYC 984 | Generalist | 1.6 |
| 31 | NCYC 985 | Generalist | 2.2 |
| 32 | NCYC 986 | Maltotriose Specialist | 1.5 |
| 33 | NCYC 987 | Maltose Specialist | 10 |
| 34 | NCYC 989 | Maltose Specialist | 10 |
| 35 | NCYC 1047 | Generalist | 3.6 |
| 36 | NCYC 1048 | Generalist | 3 |
| 37 | NCYC 1056 | Generalist | 2.2 |
| 38 | NCYC 1057 | Generalist | 3.4 |
| 39 | NCYC 1073 | Maltotriose Specialist | 1.1 |
| 40 | NCYC 1116 | Generalist | 3 |
| 41 | NCYC 1146 | Maltotriose Specialist | 0.8 |
| 42 | NCYC 1236 | Maltose Specialist | 8.2 |
| 43 | NCYC 1239 | Maltotriose Specialist | 0.7 |
| 44 | NCYC 1250 | Generalist | 2.2 |
| 45 | NCYC 1262 | Maltose Specialist | 4.1 |
| 46 | NCYC 1269 | Maltotriose Specialist | 0.4 |

| Strain # | STRAIN NAME | Type | M2rate/M3rate | Strain # | Strain Name | Type | M2rate/M3rate |
|---|---|---|---|---|---|---|---|
| 47 | NCYC 1295 | Maltotriose Specialist | 1.6 | 71 | NCYC 2921 | Maltotriose Specialist | 1.6 |
| 48 | NCYC 1296 | Maltose Specialist | 5.6 | 72 | NCYC 3419 | Generalist | 2.9 |
| 49 | NCYC 1297 | Maltotriose Specialist | 0.8 | 73 | CMB S33 | Generalist | 2.7 |
| 50 | NCYC 1305 | Maltotriose Specialist | 1.1 | 74 | NCYC 185 | Maltotriose Specialist | 0.5 |
| 51 | NCYC 1322 | Maltose Specialist | 10 | 75 | NCYC 203 | Maltotriose Specialist | 1.2 |
| 52 | NCYC 1323 | Maltose Specialist | 10 | 76 | NCYC 204 | Maltotriose Specialist | 0.5 |
| 53 | NCYC 1324 | Maltotriose Specialist | 1.3 | 77 | NCYC 227 | Maltose Specialist | 4.2 |
| 54 | NCYC 1326 | Maltotriose Specialist | 1.5 | 78 | NCYC 228 | Maltose Specialist | 5.7 |
| 55 | NCYC 1341 | Generalist | 2.6 | 79 | NCYC 229 | Maltose Specialist | 10 |
| 56 | NCYC 1342 | Generalist | 2.8 | 80 | NCYC 230 | Maltose Specialist | 10 |
| 57 | NCYC 1365 | Maltose Specialist | 6.5 | 81 | NCYC 231 | Maltotriose Specialist | 1.1 |
| 58 | NCYC 1516 | Maltotriose Specialist | 1.5 | 82 | NCYC 242 | Maltose Specialist | 10 |
| 59 | NCYC 1526 | Maltotriose Specialist | 1.3 | 83 | NCYC 392 | Maltose Specialist | 10 |
| 60 | NCYC 1544 | Maltotriose Specialist | 1.4 | 84 | NCYC 397 | Maltose Specialist | 10 |
| 61 | NCYC 2337 | Generalist | 2.1 | 85 | NCYC 398 | Maltose Specialist | 10 |
| 62 | NCYC 2338 | Generalist | 2.3 | 86 | NCYC 399 | Generalist | 2.8 |
| 63 | NCYC 2339 | Maltotriose Specialist | 1.6 | 87 | NCYC 400 | Generalist | 2.9 |
| 64 | NCYC 2340 | Maltose Specialist | 5.3 | 88 | NCYC 450 | Maltose Specialist | 8.1 |
| 65 | NCYC 2347 | Generalist | 1.7 | 89 | NCYC 451 | Maltotriose Specialist | 0.4 |
| 66 | NCYC 2359 | Maltotriose Specialist | 1.4 | 90 | NCYC 452 | Maltotriose Specialist | 0.4 |
| 67 | NCYC 2398 | Maltotriose Specialist | 1.6 | 91 | NCYC 453 | Generalist | 3.3 |
| 68 | NCYC 2426 | Generalist | 1.8 | 92 | NCYC 454 | Generalist | 2.1 |
| 69 | NCYC 2801 | Maltose Specialist | 6.1 | 93 | NCYC 455 | Generalist | 3.3 |
| 70 | NCYC 2837 | Generalist | 1.8 | 94 | NCYC 511 | Maltose Specialist | 10 |

| Strain # | Strain Name | Type | M2rate/M3rate |
|---|---|---|---|
| 95 | NCYC 584 | Maltose Specialist | 10 |
| 96 | NCYC 679 | Generalist | 3.9 |
| 97 | NCYC 680 | Generalist | 2.3 |
| 98 | NCYC 1026 | Generalist | 2.4 |
| 99 | NCYC 3420 | Maltose Specialist | 10 |
| 100 | CBS 12357 | Maltose Specialist | 10 |
| 101 | CBS 7001 | Maltose Specialist | 10 |
| 102 | CBS 1483 | Maltose Specialist | 4 to 10 |
| 103 | WS34/70-1 | | |
| 104 | CBS 679 | | |
| 105 | CBS 1174 | Maltose Specialist | 10 |
| 106 | CBS 1177 | Maltose Specialist | 10 |
| 107 | CBS 1245 | Maltose Specialist | 10 |
| 108 | CBS 1386 | Maltose Specialist | 10 |
| 109 | CBS 1484 | Generalist | 2.5 |
| 110 | CBS 1488 | Maltose Specialist | 10 |
| 111 | CBS 1502 | Maltose Specialist | 10 |
| 112 | CBS 1504 | Maltose Specialist | 10 |
| 113 | CBS 1548 | Maltose Specialist | 10 |
| 114 | CBS 1550 | Maltose Specialist | 10 |
| 115 | CBS 1551 | Maltose Specialist | 10 |
| 116 | CBS 1552 | Maltose Specialist | 10 |
| 117 | CBS 1603 | Maltose Specialist | 10 |
| 118 | CBS 1605 | Maltose Specialist | 10 |
| 119 | CBS 1606 | Maltose Specialist | 10 |
| 120 | CBS 1608 | Maltose Specialist | 10 |
| 121 | CBS 1665 | Maltose Specialist | 10 |
| 122 | CBS 2165 | Maltose Specialist | 10 |
| 123 | CBS 2442 | Maltose Specialist | 10 |
| 124 | CBS 2443 | Maltotriose Specialist | 1.2 |
| 125 | CBS 2898 | Maltotriose Specialist | 1.3 |
| 126 | CBS 2906 | | |
| 127 | CBS 2945 | Maltose Specialist | 10 |
| 128 | CBS 2954 | Maltose Specialist | 10 |
| 129 | CBS 2986 | Maltose Specialist | 10 |
| 130 | CBS 5156 | Maltose Specialist | 10 |
| 131 | CBS 5832 | Generalist | 2.5 |
| 132 | CBS 6017 | Maltose Specialist | 10 |
| 133 | CBS 6903 | Maltotriose Specialist | 1.2 |
| 134 | CBS 7240 | Maltotriose Specialist | 1.3 |
| 135 | CBS 8834 | Generalist | 3.6 |
| 136 | WS34/70 | Generalist | 2 |
| 137 | CBS 1513 | Maltotriose Specialist | 0.3 |
| 138 | NCYC 396 | | |
| 139 | yHDPN 421 | Maltose Specialist | 10 |
| 140 | yHKS 210 | Maltose Specialist | 10 |
| 141 | yHKS 212 | Maltose Specialist | 10 |
| 142 | yHKS 509 | Maltose Specialist | 10 |
| 143 | yHRVM 107 | Maltose Specialist | 10 |

### Analytical Methods

CO₂ evolution was measured continuously by means of mass flow meters (Bronkhorst, Veenendaal, The Netherlands). Optical density was measured with a Libra S60 Spectrophotometer (Biochrom Ltd., Cambridge, USA). Total cell concentration and viability were measured with a Nucleocounter YC-100 (Chemometec A/S, Allerod, Denmark). The Apparent Extract (AE) was measured with a Handheld Density Meter DMA 35 Basic (Anton Paar GmbH, Graz, Austria). HPLC analysis of sugar and metabolite concentrations was performed with an Agilent Infinity 1260 chromatography system (Agilent Technologies, Santa Clara, CA, USA) equipped with an Aminex HPX-87H column (BioRad Laboratories Inc., Lunteren, The Netherlands) at 60° C. using 5 mM H₂SO₄ as eluent at a flow rate of 0.6 mL min⁻¹. Concentrations of esters, higher alcohols and vicinal diketones were measured with an Agilent 7890A Series GC equipped with a DB-WAXetr column (Agilent) and a flame ionization detector (FID) for the analysis of ester and higher alcohols and a CP-Sil 8 CB column (Agilent) and an electron capture detector (ECD) for vicinal diketone analysis.

### Results

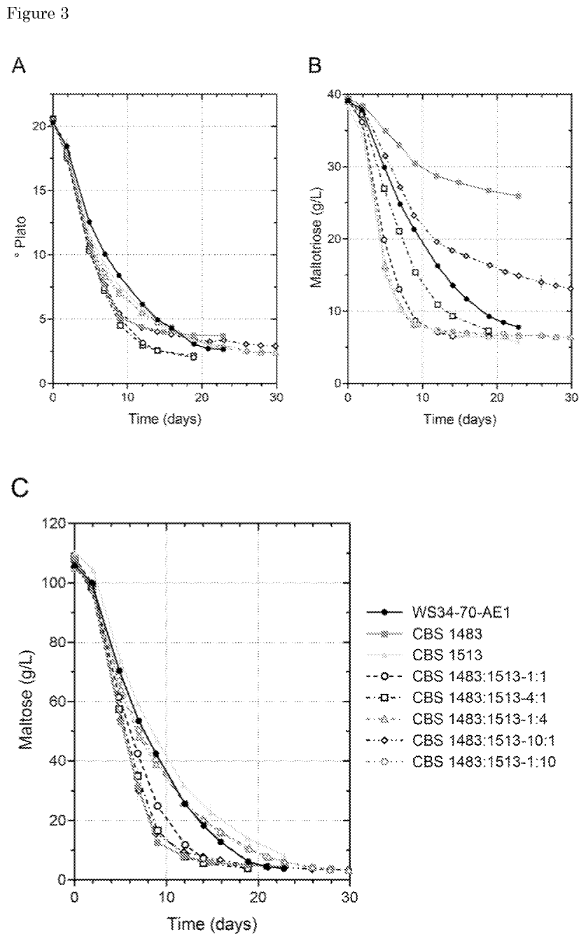

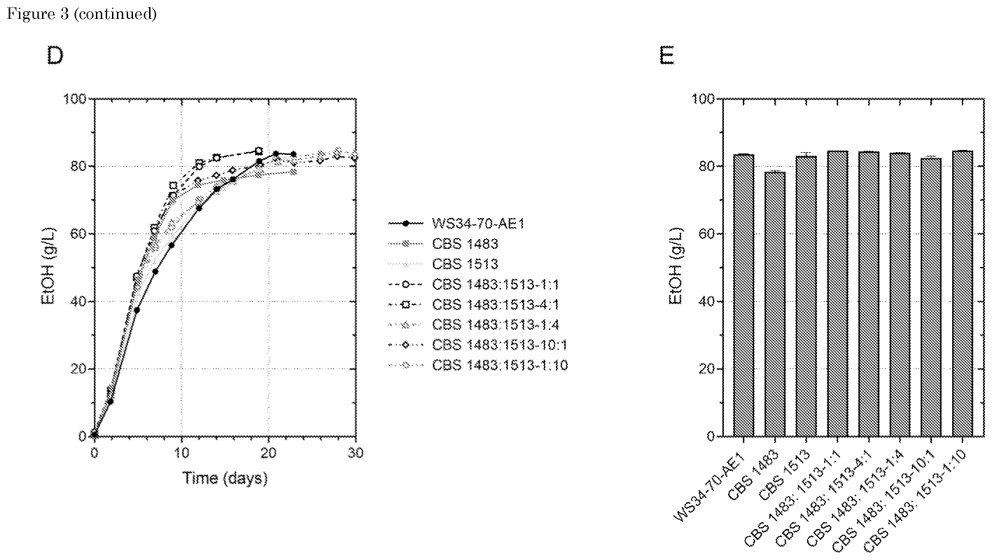

In tall tube experiments, a maltotriose specialist Saccharomyces pastorianus CBS 1513 (also termed S. carlsbergensis type strain E.C. Hansen) and a maltose specialist S. pastorianus CBS 1483 have been tested separately in 20° P wort confirming their sugar specialist behavior. See FIG. 3.

In proof-of-principle mixes, CBS 1483 and CBS 1513 have been tested in tall tubes in 20° P wort in a 1:1, 4:1 and 1:4, and 10:1 and 1:10 ratio's, and were compared to a standard generalist, WS34/70. Results show that the 1:1 and 4:1 (CBS1483:CB1513) mixtures reached an attenuation to a density of 2.5° P 10 days ahead of a 20° P W34/70 fermentation (FIG. 3A). Residual maltotriose concentration for the 1:1, 1:4 and 1:10 (CBS1483:CBS1513) mixtures was below 10 g/L from about 10 days onwards, which is comparable to the maltotriose specialist. The residual maltotriose concentration for W34/70 was about 20 g/L at 10 days, and about 30 g/L at 10 days for the maltose specialist (FIG. 3B). The residual maltose concentration after 10 days of fermentation for the 1:1, 4:1 and 10:1 mixtures was about 5 g/L, while both WS34/70 and the maltotriose specialist reached these values after 20 days, so 10 days later (FIG. 3C).

Ethanol production was accelerated for the 1:1, 4:1 and 10:1 (CBS1483:CBS1513) mixtures, when compared to WS34/70 (FIG. 3D), while the final amounts of produced ethanol was comparable in WS34/70 and all mixtures (FIG. 3E).

Further variables that were analysed, including pH, CO₂ production, glucose consumption, fructose consumption, and generation of esters, higher alcohols and vicinal diketones, did not vary significantly between the different cultures.

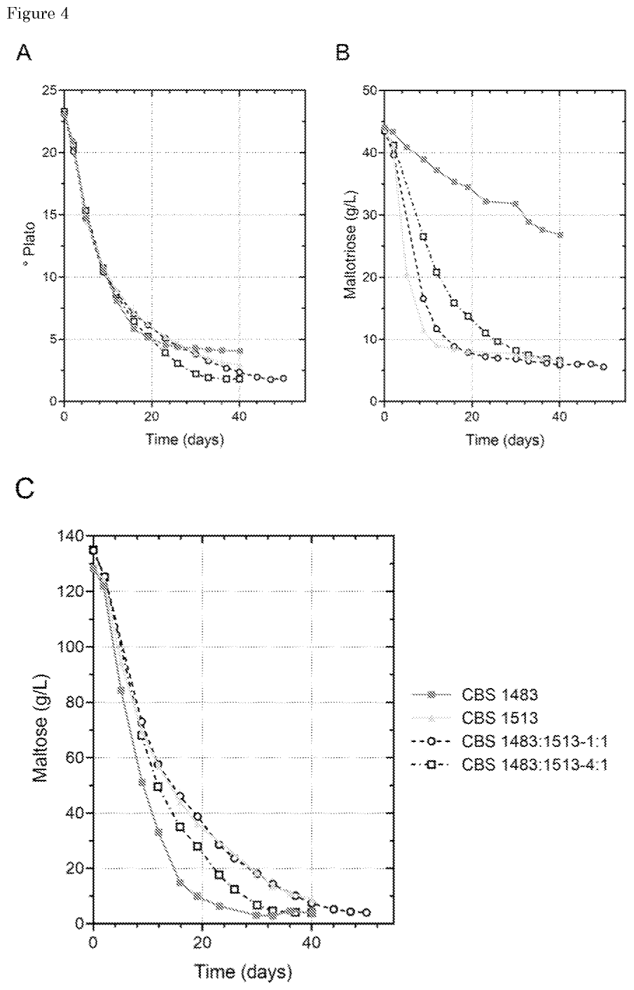

Comparable data were obtained for the individual strains and mixtures when tested in tall tubes in 23 ºP wort. Results show that the 1:1 and 4:1 mixtures reached an attenuation to a level of 2.5° P earlier than the parent strains (FIG. 4A). Residual maltotriose concentration for the 1:1, 1:4 and 1:10 mixtures was comparable to the maltotriose specialist, and lower than for WS34/70 and for the maltose specialist, while the residual maltose concentration for the 1:1, 4:1 and 10:1 mixtures was comparable to the maltose specialist (FIG. 4B).

Ethanol production was accelerated for the 4:1 mixture, when compared to the individual strains (data not shown). The 4:1 mixture was found to finish in about 3% of the time required for the other strains.

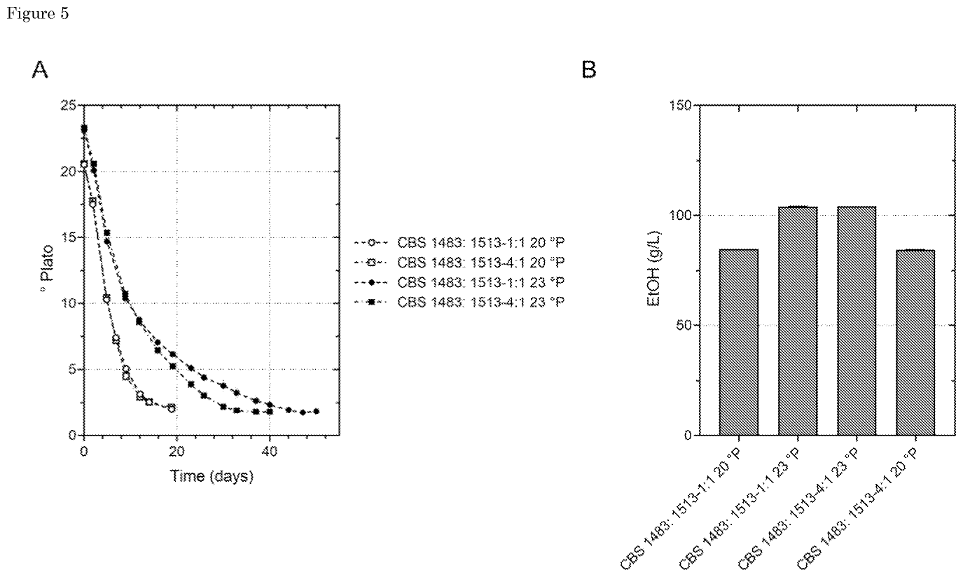

When comparing mixes of strains with different substrate specificities for 20° P and 23° P, it can be seen that 1:1 and 4:1 mixes reach an attenuation of 2.5° P ahead of 23° P starting wort. In addition, the final ethanol production when starting with 23° P wort is about 20% higher (see FIG. 5A,B).

It is concluded that a mix of strains with different substrate specificities, such as CBS 1513 and CBS 1483, result in a faster ethanol production, when compared to the individual strains or to the industry standard (W34/70).

### Example 3

### Materials and Methods

Saccharomyces strains: Superstart™ and Thermosacc® were both kindly provided by Lallemand Biofuels & Distilled Spirits, Milwaukee, WI). The co-cultures were performed in 3 L stainless steel tall tubes with a working volume of 2.25 L in 23° P VHG wort. Temperature was controlled at 12° C. by means of a Lauda ECO RE 415 G cryostat. Total cell concentration and viability were measured with a Nucleocounter YC-100 (Chemometec A/S, Allerod, Denmark). The Apparent Extract (AE) was measured with a Handheld Density Meter DMA 35 Basic (Anton Paar GmbH, Graz, Austria). HPLC analysis of sugar and ethanol concentrations was performed with an Agilent Infinity 1260 chromatography system (Agilent Technologies, Santa Clara, CA, USA) equipped with an Aminex HPX-87H column (BioRad Laboratories Inc., Lunteren, The Netherlands) at 60° C. using 5 mM H₂SO₄ as eluent at a flow rate of 0.6 mL min-1.

### Results

To check whether a mixture of the strains Superstart™ and Thermosacc®, as proposed in WO2013/181496), could efficiently consume a mixture of glucose, maltose and maltotriose from wort, a mixture of the two strains in 1:1 ratio was used to inoculate 23° P VHG wort. These Saccharomyces cerevisiae strains are active dry yeasts for use in fuel ethanol and beverage alcohol fermentations. Superstart is a distillers yeast that was selected for a rapid fermentation start and stress tolerance to temperature, pH and osmotic stress. This strain was also characterized as a maltotriose positive strain.

Thermosacc® is a Saccharomyces cerevisiae distillers yeast selected for use in high-gravity fermentations at high temperatures and high sugar and alcohol concentrations. It works well at temperatures up to 38° C. and alcohol concentrations of more than 20% by volume (16% by weight).

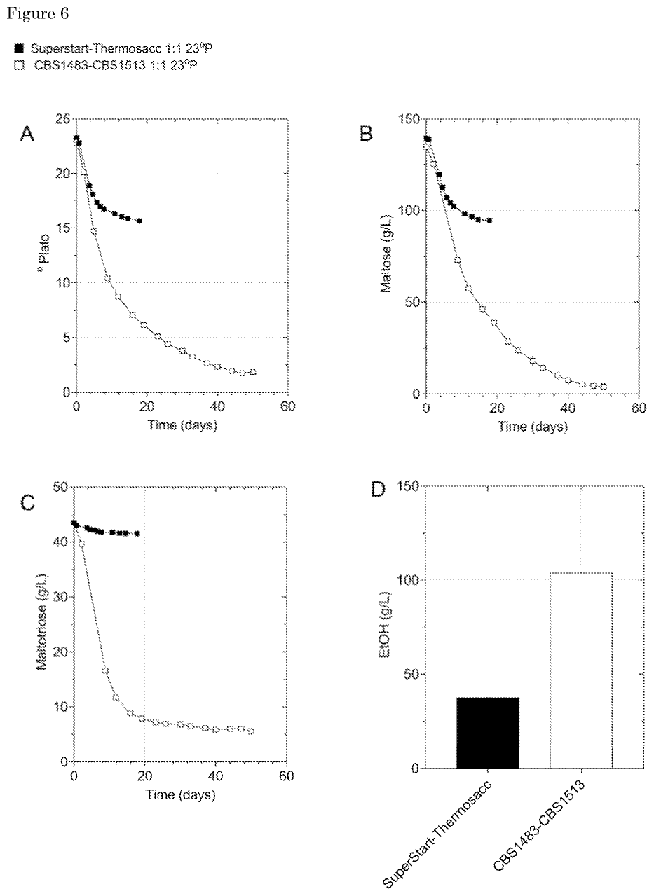

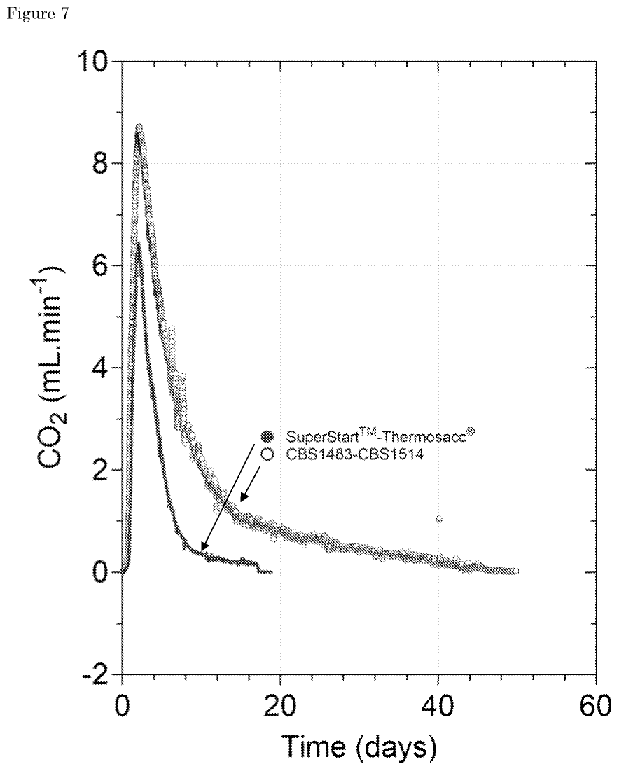

The fermentation was carried at 12° C. in 3-L stainless steel tall tubes (E.B.C. Analytica Microbiologica, 1977. J Institute Brewing 83:109-118) with a working volume of 2.25 L and equipped with a water cooling jacket (Leemberg, Zwijndrecht, The Netherlands). The results of quadruplicate fermentations were compared to results of a mixture of specialists CBS1483:CB1513 at an initial ratio of 1:1 (FIG. 4). As anticipated, the two commercial strains initially selected for efficient fermentation at high temperature above 30° C., were not fermenting efficiently at low temperature below 30° C. The results show that a 1:1 ratio of the strains Supersart™ and Thermossac reached an attenuation 15.5° P after 19 days (FIG. 6A). At that time the strain mixture was not metabolically active any longer as shown by the CO₂ profile that reached baseline (null) values (FIG. 7). The concentration of the individual sugars showed that only 32% (44.8 g L⁻¹) and 4.5% (4.5 g L⁻¹) of maltose and maltotriose, respectively, was consumed (FIGS. 6B and 6C). This resulted in low ethanol concentration relative to the CBS1483-CBS1513 co-cultivation (FIG. 6D).

As a matter of comparison in similar conditions a CBS1483:CBS1513 mixture in a 1:1 ratio reached values below 7° P at 20 days and were able to further attenuate to 2.5° P after 40 days (FIG. 4). At 19 days the co-cultures of the CBS strains consumed 83% of maltotriose and 76% of maltose initially present (FIG. 4).

These results showed that although Superstart and Thermosacc have been selected for their excellent fermentation characteristics they are not suitable for wort fermentation at low temperature to produce a fermented beverage such as is a beer, preferably a lager beer.

1. A method of producing a fermented beverage, comprising the steps of:
providing a wort;
adding hop and at least two fermentative yeast strains to the wort, whereby said at least two fermentative yeast strains differ in their substrate specificities towards sugars in the wort;
incubating the wort with the at least two fermentative yeast strains for a period of time;
optionally removing the at least two fermentative yeast strains from the fermented wort,
thus producing the fermented beverage.

2. The method of claim 1, wherein the wort is a high gravity wort, having a gravity of more than 16° Plato.

3. The method of claim 1, wherein the at least two fermentative yeast strains are simultaneously or sequentially added to the wort.

4. The method of claim 1, wherein an apparent attenuation of the fermented beverage is at least 0.8.

5. The method of claim 1, wherein the wort is a high gravity wort, and fermentation of the wort results in the fermented beverage having a final gravity of less than 2.5° Plato within 15 days of fermentation.

6. The method of claim 1, wherein said at least two fermentative yeast strains are Saccharomyces cerevisiae, S. pastoriamis, S. eubayanus yeast strains, or a mixture of hybrid thereof.

7. The method of claim 1, wherein fermentation is performed at 6-25° C.

8. The method of claim 1, wherein the fermented beverage is a beer.

9. The method of claim 1, wherein the at least two fermentative yeast strains each comprise a Saccharomyces pastorianus strain CBS 1483 having maltotriose substrate preference.

10. The method of claim 1, wherein the at least two fermentative yeast strains each comprise a S. pastorianus strain CBS 1513 having maltotriose substrate preference.

11. A fermented beverage that is lager beer, that has a high alcohol content of more than 5% alcohol by volume (ABV).

12. The fermented beverage that is produced by the method of claim 1.

13-15. (canceled)

16. The method of claim 1, wherein the sugars in the wort comprise glucose, fructose, maltose, maltotriose, or a combination thereof.

17. The method of claim 1, wherein the wort comprises a high gravity wort of more than 16° Plato, and fermentation of the wort results in the fermented beverage having a final gravity of less than 2.5° Plato within 15 days of fermentation.

18. The method of claim 1, wherein fermentation is performed at 8-15° C.

19. The method of claim 1, wherein the fermented beverage is a lager beer.

20. The fermented beverage of claim 11, that has an alcohol content of more than 6% alcohol by volume (ABV).

21. The fermented beverage of claim 11, that has an alcohol content of more than 6% ABV.
